(19) United States
(12) Patent Application Publication
(10) Pub. No.: US 2025/0351836 A1
(43) Pub. Date: Nov. 20, 2025

(54) SEED EXTRACT FOR USE DURING FOOD COOKING AND STORAGE PROCESSES

(71) Applicant: KHALIFA UNIVERSITY OF SCIENCE AND TECHNOLOGY, Abu Dhabi (AE)

(72) Inventors: Fawzi Banat, Abu Dhabi (AE); Vengatesan Muthukumaraswamy Rangaraj, Abu Dhabi (AE); Khadija Farousha, Abu Dhabi (AE); Rambabu Krishnamoorthy, Abu Dhabi (AE); Ebrahim Al Hajri, Abu Dhabi (AE)

(73) Assignee: KHALIFA UNIVERSITY OF SCIENCE AND TECHNOLOGY, Abu Dhabi (AE)

(21) Appl. No.: 18/664,357

(22) Filed: May 15, 2024

(51) Int. Cl. A23D 9/06; A23L 5/10; A23L 19/00

(52) U.S. Cl. CPC A23B 20/30; A23L 5/11; A23L 19/09

(57) ABSTRACT

Some embodiments of the present disclosure relate to a naturally occurring composition, such as a seed extract, which can be used as an additive in edible oils. The additive may reduce or prevent chemical reactions that occurring during a food cooking process, such as a frying processes and/or food storage process where chemical reactions reduce the quality of the edible oil. Some embodiments of the present disclosure relate to a composition for use in a food-frying process and/or a food storage process. In some embodiments of the present disclosure the composition is made with an edible oil and a date seed extract (DSE).

### TECHNICAL FIELD

This disclosure generally relates to an additive for use during a high-temperature process. In particular, this disclosure relates to a seed extract for use as a stabilizer of an edible oil during a food cooking or storage process.

### BACKGROUND

It is known to use naturally occurring compounds as preservatives for a wide range of foods for at least the reason of increasing a shelf life of the food. Edible oils are commonly consumed by humans. Edible oils may act as a source of essential fatty-acids and vitamin E. Edible oils are widely used to prepare fried foods at high temperatures. As a result of prolonged and repeated exposure to high temperatures during food-frying processes, edible oils may undergo various chemical changes, such as but not limited to: hydrolysis of triacylglycerols, oxidation of fatty acids, polymerization, and isomerization. These chemical changes of edible oils result in a loss of nutrients, color, flavor, texture, and a decreased shelf-life. Furthermore, the chemical changes can generate free radicals, which can produce potentially toxic compounds that reduce the nutritional value of foods and can negatively impact the consumer's health.

The oxidation of fatty acids within edible oils, while being used in a food-frying process, can occur quickly and result in the deterioration of edible-oil quality and loss of customer acceptance, leading to significant economic losses in the edible-oil industry.

It is known to use synthetic preservatives such as butylated hydroxy anisole (BHA), butylated hydroxytoluene (BHT), tert-butylhydroquinone (TBHQ), and propyl gallate (PG) to prevent the oxidation reaction from occurring and, therefore, to improve the oxidative stability of foods that comprise edible oils. However, when used in food-frying processes synthetic preservatives are known to be-or become-toxic with some synthetic preservatives demonstrating carcinogenic properties.

As such, it may be useful to explore additives that address the issues that arise when using edible oils in food-frying processes, while reducing or avoiding the shortcomings of using synthetic preservatives.

### SUMMARY

Some embodiments of the present disclosure relate to a naturally occurring composition, such as a seed extract, which can be used as an additive in edible oils. The additive may reduce or prevent chemical reactions that occurring during a food cooking process, such as a frying processes where such chemical reactions reduce the quality of the edible oil.

Some embodiments of the present disclosure relate to a composition made with an edible oil and a date seed extract (DSE).

Some embodiments of the present disclosure relate to a composition for use in a food-frying process. The composition comprises an edible oil component, and a date seed extract.

Some embodiments of the present disclosure relate to a composition for use in a food-cooking process, such as frying, or a food-storage process. The composition comprises an edible oil component, and a naturally occurring composition that comprises a combination of a hydroxycinnamate, an organic acid, a flavan-3-ol, a flavonol, a flavone, an anthocyanin derivative or any combination thereof.

Some embodiments of the present disclosure relate to a food-frying process comprising the steps of heating an edible oil and a DSE; and positioning a food product into the heated edible oil and DSE.

Without being bound by any particular theory, the embodiments of the present disclosure relate to a DSE and its use as a natural antioxidant to improve the oxidative stability of edible oils during discontinuous frying at high temperatures. DSEs contain a large number of active phytochemical compounds, including carotenoids, sterols, polyphenols, flavonoids, quinones, and anthocyanins, as confirmed by the Liquid chromatography-mass spectroscopic (LC-MS) analysis (see the supporting information). Therefore, the DSE, according to the embodiments of the present disclosure, can be used as an excellent natural antioxidant preservative.

Without being bound by any particular theory, the presence of polyphenol compounds in the DSE may contribute to controlling the oxidation of food during a high temperature, food-frying process. While various natural antioxidants in cooking oil have been thoroughly investigated for their oxidative stability during high-temperature frying. To the inventor's knowledge, DSE has not been reported as suitable for use as a natural antioxidant, especially for high-temperature, food-frying operations.

Without being bound by any particular theory, the DSE of the present disclosure was selected as a natural antioxidant preservative for such application due to its low toxicity and biocompatibility, as compared to known synthetic antioxidants. Moreover, the DSE is obtained from the date seeds, which may be a viable strategy to upgrade a known waste stream into a valuable composition with antioxidant properties and to minimize accumulation of solid wastes.

### BRIEF DESCRIPTION OF THE DRAWINGS

These and other features of the present disclosure will become more apparent in the following detailed description in which reference is made to the appended drawings.

FIG. 1A through FIG. 1H shows liquid chromatography-mass spec (LC-MS) ion spectra of hydroxycinnamate phytochemical components in date seed extract (DSE) ([M−H]−/[M+H]+(m/z)).

FIG. 2A and FIG. 2B shows LC-MS ion spectra of other organic acid phytochemical components in DSE ([M−H]−/[M+H]+(m/z)).

FIG. 3A through FIG. 3E shows LC-MS ion spectra of flavan-3-ol phytochemical components in DSE ([M−H]−/[M+H]+(m/z)).

FIG. 4A through FIG. 4H shows LC-MS ion spectra of flavonol and flavone phytochemical components in DSE ([M−H]−/[M+H]+(m/z)).

FIG. 5A through FIG. 5E shows LC-MS ion spectra of further flavonol and flavone phytochemical components in DSE ([M−H]−/[M+H]+(m/z)).

FIG. 6A through FIG. 6H shows LC-MS ion spectra of anthocyanin derivative phytochemical components in DSE ([M−H]−/[M+H]+(m/z)).

FIG. 7A through FIG. 7D shows histograms of physicochemical changes observed in sunflower oil supplemented with different concentrations of DSE (200 ppm, 400 ppm, 600 ppm, 800 ppm and 1000 ppm) and TBHQ (200 ppm) used in the potato deep-frying process, where FIG. 7A shows acid value data, FIG. 7B shows peroxide value data, FIG. 7C shows anisidine value data, and FIG. 7D shows TOTOX value data. This data is expressed in terms of mean±SD and represent the mean of 3 independent replicates. Means±standard error within a column with the same uppercase letters is not significantly different at p<0.05. Means±standard error within a row with the same lowercase letters is not quite different at p<0.05.

FIG. 8 shows a histograms of observed changes in iodine value of sunflower oil enriched with different amounts of DSE (200 ppm, 400 ppm, 600 ppm, 800 ppm and 1000 ppm) and TBHQ (200 ppm) over 5 cycles/days of the potato-frying process. This data is expressed as mean±SD and represent the mean of 3 independent replicates. Means±standard error within a column with the same uppercase letters is not significantly different at p<0.05. Means±standard error within a row with the same lowercase letters is not quite different at p<0.05.

### DETAILED DESCRIPTION

In use, natural antioxidants can have similar effects to synthetic preservatives in regards to reducing or preventing chemical modifications of edible oils during a food-frying operation, while the natural antioxidants may provide the benefits of not being harmful to humans. Natural antioxidants may help to control the problem of lipid oxidation of edible oil during a food-frying process. Natural antioxidants are mainly derived from plant sources, agricultural by-products, and food waste such as essential oils (EOs) and polyphenol extracts. Natural antioxidants have also received much attention as sources of biologically active compounds with various health-promoting effects. Natural antioxidants with high polyphenol content prevent oxidative rancidity of edible oils by: (i) capturing free radicals; (ii) degrading and deoxidizing peroxides; and, (iii) scavenging the radical oxygen process. Without being bound to any particular theory, natural antioxidants from agricultural by-products, including fruit peels and seed extracts, can be an attractive, viable, and cost-effective alternative to synthetic preservatives by reducing disposal costs and increasing the value of the by-product. Indeed, the global natural-antioxidant market grew to $2.31 billion in 2022 and is expected to reach $3.62 billion by 2027.

As used herein, the term “about” refers to an approximately +/−10% variation from a given value. It is to be understood that such a variation is always included in any given value provided herein, whether or not it is specifically referred to.

The embodiments of the present disclosure will now be described by reference to the figures, which show representations of the apparatus, systems and methods according to the present disclosure.

Some embodiments of the present disclosure relate to a composition that is suitable for use in a food-cooking process, such as a food-frying process, and for use in a food preparation and storage process. The composition comprises an edible oil component and a date seed extract (DSE).

According to the embodiments of the present disclosure, the edible oil component comprises a plant-based edible oil, an animal-based edible oil or any combination thereof.

In some embodiments of the present disclosure, the plant-based edible oil may be an avocado oil, an almond oil, an brazil nut oil, a canola oil, a cashew oil, a cocoa oil, a coconut oil, a corn oil, a cottonseed oil, a grapeseed oil, a hazel nut oil, a hemp oil, a macadamia nut oil, a palm oil, a rapeseed oil, a soybean oil, a mustard oil, a palm oil, a peanut oil, a rice bran oil, a safflower oil, an olive oil, a sesame oil, a sunflower oil, a walnut oil, a vegetable oil, a linseed oil or any combination thereof.

In some embodiments of the present disclosure, the DSE comprises a phenolic acid, a flavonoid, a flavone, a proanthocyanidin or any combination thereof.

In some embodiments of the present disclosure, the DSE comprises a hydroxycinnamate, an organic acid, a flavan-3-ol, a flavonol, a flavone, an anthocyanin derivative or any combination thereof.

In some embodiments of the present disclosure, the hydroxycinnamate may be caffeoyl-O-hexoside, 5-O-caffeoylshikimic acid (5-CSA), 4-O-caffeoylshikimic acid (5-CSA), 3-O-caffeoylshikimic acid (5-CSA), caffeoyl-2-hydroxyethane-1,1,2-tricarboxylic acid, feruloyl-O-p-coumaroyl-O-caffeoylshikimic acid, 3-O-feruloyl-7-O-acyl-feruloyl-4-O-caffeoyl-quinic acid, tri-caffeoylquinic acid or any combination thereof.

In some embodiments of the present disclosure, the organic acid may be trihydroxy-octadecanoic acid isomer, trihydroxyoctadecanoic acid sulphate or any combination thereof.

In some embodiments of the present disclosure, the flavan-3-ol may be (E) Catechin, (E) Catechin-(E) Catechin-(E) Catechin, (E) Catechin-(E) Catechin-(E) Catechin, (E) Catechin-(E) Gallocatechin, (E) Catechin-(E) Catechin or any combination thereof.

In some embodiments of the present disclosure, the flavanol and flavones may be hexosylquercetin, dihexosylquercetin, gliricidin or 3-O-methylorobol, rhamnosylhexosyl luteolin, isorhamentin, rhamnosylhexosyl methyl quercetin, isorhamentin hexoside, kaempferol, isorhamentin, orientin, iso-orientin, orientin sulphate, iso-orientin sulphate, quercetin rutinoside, gliricidin, 3-O-methylorobol, chrysoeriol hexoside, quercetin or any combination thereof.

In some embodiments of the present disclosure, the anthocyanin derivative may be cyanidin 3-O-glucoside, delphinidin-3-O-glucoside, petunidin-3-O-glucoside, peonidin-3-O-glucoside, malvidin-3-O-glucoside, cn-3-(6″-p-coumaroylglucoside), pt-3-(6″-p-coumaroylglucoside), dp-3-(6″-p-coumaroylglucoside) or any combination thereof.

In some embodiments of the present disclosure, the DSE is present within the composition at a desired concentration so that the fatty acid constituents of the edible oil are protected from modifying chemical reactions that can decrease the quality of the edible oil. In other words, when the DSE is present in the edible oil the fatty acids within the edible oil will be subjected to less oxidation, free radical generation, rancidification so that the edible oil may be used at higher temperatures, for longer frying events, for multiple frying events or the like while producing a fried food product that is appealing to consumers. In some embodiments of the present disclosure the desired concentration of the DSE is between about 10 parts per million (ppm) and about 2500 ppm or at a concentration of between about 25 ppm and about 2250 ppm or at a concentration of between about 50 ppm and about 2000 ppm or at a concentration of between about 75 ppm and about 1750 ppm or at a concentration of between about 100 ppm and about 1500 ppm or at a concentration of between about 150 ppm and about 1250 ppm or at a concentration of between about 200 ppm and about 1000 ppm. In some embodiments of the present disclosure the DSE is present within the composition at a desired concentration of about 25 ppm, 50 ppm, 75 ppm, 100 ppm, 150 ppm, 200 ppm, 300 ppm, 400 ppm, 500 ppm, 600 ppm, 700 ppm, 800 ppm, 900 ppm, 1000 ppm, 1100 ppm, 1200 ppm, 1300 ppm, 1400 ppm, 1500 ppm or more.

The composition of claim 5, wherein the date seed extract is present within the composition at a concentration of between 25 ppm and 1500 ppm.

In some embodiments of the present disclosure the composition is suitable for use in a food-cooking process. Examples of such food-cooking processes include high temperature processes such as, but not limited to: frying, baking, roasting and the like. The composition includes an edible oil component and a DSE component. The two components may be mixed together to achieve a desired concentration of the DSE within the composition before or during the food-frying process. The food-frying process may allow for the composition to be re-used for multiple frying events and, in some embodiments of the present disclosure, the composition may be supplemented with more of the DSE component.

In some embodiments of the present disclosure relate to the composition is suitable for use in a food preparation and/or storage process. The composition includes an edible oil component and a DSE component. The two components may be mixed together before being added to the food that is being prepared and/or stored.

### EXAMPLES

### Materials

Date seeds (Khalas variety) were collected from a local market in Abu Dhabi, UAE. Virgin sunflower oil without antioxidants was brought from a local oil shop in Abu Dhabi, UAE. Analytical-grade chemicals, reagents, and solvents were purchased from Sigma-Aldrich and used without further purification.

### Preparation of Date Seed Extract (DSE)

DSE was extracted from the date seed powder using the Soxhlet extraction method, as reported in Farousha, K., M. Rangaraj, V., K, R., Abu Haija, M., Banat, F., 2023. Development of date seed extract encapsulated MCM-41: Characterization, release kinetics, antioxidant and antibacterial studies, Food Bioscience 53, 102563, the entire contents of which are incorporated herein by reference. In brief, a dried date seeds powder was mixed with ethanol in a 5:1 (v/w) ratio and continuously extracted for 5 hours. The DSE was then freeze-dried in at −20° C. for about 12 hours before being stored in an airtight container at 5° C. for further use.

### Liquid Chromatography-Mass Spectroscopy (LC-MS) Analysis

High-performance liquid chromatography (HPLC) analyses were conducted utilizing a Waters Alliance system (Waters Chromatography), coupled with a photodiode array detector (PDA) and interfaced with an electrospray ionization source (ESI) and a single quadrupole analyzer mass detector (MS). A sample separation (10 μl) was executed on an Acquity UPLC Kinetex® C18 column (Phenomenex, Kinetex® 2.6 μm C18 100 Å, 150 mm×2.1 mm i.d.) maintained at 25° C., with a flow rate of 0.6 ml min-1. The injection volume was set at 0.6 μl. The mobile phase comprised A: Water and B: methanol, both acidified with 0.1% acetic acid. The gradient used was as follows: 0-5 min, 2% B; 5-10 min, 2%-15% B; 10-30 min, 15%-30% B, 30-45 min, 30%-98% B; 45-70 min, 98%-2% B; followed by a final isocratic step for 5 min at 2% B. PDA detection spanned the 200-800 nm wavelength range, and mass spectra were recorded in both negative and positive ion modes with the following settings: capillary voltage: 3 kV; cone voltage: 10 V, desolvation temperature: 600° C., and ion source temperature: 150° C. Spectra were acquired in the m/z range of 80-1500 amu. Tentative identification of phenolic compounds relied on comparing ultraviolet (UV) absorption and mass fragmentation spectra with those of previously described compounds in P. dactylifera seed extract (Khalas variety).

### Determining Total Phenolic Content (TPC) in DSE

The Folin-Ciocalteu regent colorimetric method was used to determine the total phenolic compounds in the prepared DSE. In brief, 500 μL of DSE was mixed with 2.5 mL of Folin-Ciocalteu reagent and allowed to stand for 5 minutes. Subsequently, 2.0 mL of sodium carbonate (7.5 wt %) was slowly added to the solution. The samples were kept in the dark, and after 60 min, the absorbance of the solution sample was measured at 760 nm using a UV spectrophotometer (SHIMADZU UV-1900i, Japan). A calibration curve using known concentrations of gallic acid was prepared as a standard.

The TPC value of the film was calculated by the following Equation 1 (Eq. 1):

$$Total phenolic content ( mg / g ) = C \times V / M \qquad ( Eq . 1 )$$

where C denotes the concentration of phenolic compounds in terms of gallic acid (mg/mL), V is the volume of the film extract solution (mL), and M is the weight of the film sample (g).

The results were expressed in mg of gallic acid equivalent per gram of DSE (mg GAE/g).

### Antioxidant Capacity of DSE

In brief, 500 μL of each sample at various dilutions was blended in the dark with 1.5 mL of a 0.1 mM methanolic DPPH solution. After leaving the mixture in the dark for 60 minutes at room temperature, the decrease in absorption was measured at 517 nm using a spectrophotometer (SHIMADZU UV-1900i, Japan). All analyses were carried out in triplicate, and the mean value of DPPH radical scavenging efficiency was calculated using the formula shown in Equation 2 (Eq.2):

$$DPPH radical scavenging efficiency ( \% ) = \frac{{A}_{b} - {A}_{s}}{{A}_{b}} \times 100 \qquad ( Eq . 2 )$$

where A_{b} represents the DPPH ethanolic solution absorbance value in the absence of a sample (blank) and As represents the DPPH ethanolic solution absorbance value with the sample.

### Deep-Frying Experiment Using DSE

Deep-frying experiments using potatoes were performed to determine the effect of DSE on the oxidative stability of sunflower oil (but one example of an edible oil) under deep-frying conditions. DSE was added to sunflower oil as a natural antioxidant at five different concentrations: 200, 400, 600, 800, and 1,000 ppm. Similarly, 200 ppm of tert-Butylhydroquinone (TBHQ, a known synthetic antioxidant) was added to sunflower oil in order to compare the natural antioxidant impact on the oxidative stability of sunflower oil deep-frying conditions. The antioxidant-rich oils were then heated for 25 hours in a 2.5 L stainless steel frying pan (Tefal AzuraFrench) at 180° C. A first frying-cycle was carried out with potato strips and an oil ratio of 1:10 (wt/wt) in the fryer's oil. The potato strips were fried until they reached the desired color and texture. Further frying-cycles were performed at half-hour intervals. The frying process was carried out for 5 hours per day, with 10 frying cycles performed in total. The same oil was used for frying continuously for 5 days without any oil or additive replenishment. As a result, each batch of oil went through 50 frying cycles. At the end of each day ((day-1) 5 hours, (day-2) 10 hours, (day-3) 15 hours, (day-4) 20 hours, and (day-5) 25 hours), around 10 g and oil samples filtered and fried potato strips were collected and stored in amber-colored sealed glass bottles at 4° C.

### Determining Physicochemical Properties and Oxidative Stability of the Oil

### Acid Value (AV)

Briefly, 10 g of each oil sample was dissolved in 50 ml of petroleum ether and ethanol (1:1 v:v). Then, these mixtures were titrated with potassium hydroxide (0.1 M) in the presence of phenolphthalein until a pink color developed. A blank sample was carried out under the same previous conditions; the AV was then calculated using Equation 3 (Eq.3) and expressed in (mg KOH/g oil):

$$Acid value ( mg KOH / g oil ) = \frac{( V - Vb ) \times N \times 56.1}{W} \qquad ( Eq . 3 )$$

where (V) and (V_{b}) are the volumes of potassium hydroxide used in titrating the samples and the blank, respectively; (N) is the normality of potassium hydroxide; and (W) is the sample weight.

### Peroxide Value (PV)

The peroxide value (PV) was determined by the iodometric method described by Abdo, E. M., Shaltout, O. E., Mansour, H. M. M., 2023. Natural antioxidants from agro-wastes enhanced the oxidative stability of soybean oil during deep-frying. LWT 173, 11432, the entire contents of which are incorporated herein by reference. About 5 g of oil samples were mixed with 50 ml of an acetic acid/chloroform mixture (3:2 v: v) and 1 ml of a saturated potassium iodide solution. The mixture was then shaken for 5 minutes in the dark, combined with 100 ml of DI water, and titrated with sodium thiosulfate (Na₂S₂O₃) (0.01 N) until the yellow color vanished. Then, the samples were mixed with 5 ml of starch solution (1%) and vigorously shaken while being re-titrated with Na₂S₂O₃ until the blue color disappeared. The PV was calculated using Equation 4 (Eq. 4) and expressed in (m.eq O₂/Kg):

$$Peroxide value ( meq {O}_{2} / Kg ) = \frac{( V - Vb ) \times N \times 1000}{W} \qquad ( Eq . 4 )$$

where (V) is the volume of Na₂S₂O₃ used in titrating the samples; (Vb) is the volume of Na₂S₂O₃ used in titrating the blank; (N) is the normality of the Na₂S₂O₃; (W) is the weight of the oil sample.
p-Anisidine Value (p-AnV)

To determine the p-AnV value, around 2 g of each oil sample was mixed with 25 ml of iso-octane, and measured its absorbance at 350 nm versus a blank of iso-octane (A1). Then, 5 ml of the mixture was combined with 1 ml of p-anisidine/glacial acetic acid (0.25:100 w/v). After 10 min, the absorbance of the mixture was re-measured at 350 nm against a blank of iso-octane and p-anisidine (A2). p-AV was calculated from Equation 5 (Eq.5):

$$p - AnV = \frac{25 \times ( 1.2 \times A 2 - A 1 )}{W} \qquad ( Eq . 5 )$$

where (A1) is the absorbance of the oil sample in iso-octane, (A2) is the absorbance of samples after adding p-anisidine, and (W) is the oil sample weight (g).

### Total Oxidation Value (TOTOX)

TOTOX value was calculated as depicted in Equation 6 (Eq.6) as an indicator of the oil's oxidative degradation:

$$TOTOX = ( 2 \times PV ) + p - AV \qquad ( Eq . 6 )$$

Where (PV) is the peroxide value and (p-AV) is the para-anisidine value

### Total Polar Compound (TPC) Content

TPC content of the oil samples was measured through the AOCS official method Cd 20-9. About 2.5 g of each oil sample was dissolved in a mixture of petroleum ether and ether (87:13, v/v) and was then poured into a 100-200 mesh silica gel column. Approximately 200 mL of a nonpolar fraction was eluted from the oil sample dissolved petroleum ether and diethyl ether (87:13, v/v) mixture. The eluted solution was distilled under vacuum conditions, and the residue was further vacuum dried at 45° C. for 15 minutes. The nonpolar fraction sample container was cooled and weighed. Then, the TPC content was calculated as per Equation 7 (Eq.7)

$$TPC content ( \% ) \frac{( W 1 - W 2 )}{W 1} \times 100 \qquad ( Eq . 7 )$$

### Iodine Value (IV) Analysis

The iodine value (IV) in the oil samples was determined by the Wijs method, as described in the AOAC Official Method 993.20. About 0.2 g of each oil sample was dissolved in 15 ml of cyclohexane-acetic acid (1.1; v/v) solvent. Then, 25 ml of the Wijs solution [Iodine chloride (ICI) in acetic acid] was added to this mixture and kept in the dark for 1 h. Subsequently, 20 ml of 15% KI solution and 150 ml of distilled water were added to this mixture and shaken for 5 minutes. Then, the mixture was titrated against 0.1 M Na₂S₂O₃ solution, vigorously shaking until the dark brown color disappeared. The blank was analyzed under similar conditions. The IV was expressed as a gram of iodine absorbed per 100 g sample (g I₂/100 g) and was calculated using Equation 8 (Eq.8):

$$IV = \frac{( B - S ) \times M \times 12.69}{W} \qquad ( Eq . 8 )$$

where B denotes the titration value of the blank solution (ml); S represents the titration value of test solution (ml); M-molarity of Na₂S₂O₃ solution (mol/L); W-weight of the oil sample (g).

### Color Analysis

Color analysis of the samples was conducted with a colorimeter (NH310, Shenzhen 3nh Technology Co. Ltd.). After calibration of the device through the original oil (before frying condition), the color of the oil samples was described by L*, a*, and b* color scale.

### Sensory Analysis

A sensory examination of the deep fried potato samples, at various time intervals, was performed to determine the influence of antioxidants on their overall acceptability. The sensory evaluation of the deep fried potato samples prepared in control and antioxidant-enriched oils was performed by 25 semi-trained panelists (Ages 18-50) from the Department of Chemical and Petroleum Engineering, Khalifa University, UAE. Color, sharpness, taste, and general acceptability were all evaluated on a 9-1 hedonic scale, with one representing “dislike extremely” and nine representing “like extremely.”

### Statistical Analysis

All measurements were performed in triplicate. Experimental data were analyzed using analysis of variance (ANOVA). The major difference in the experimental results has been measured and compared using Tukey Multiple Comparison Test (p≤0.05).

### Results

### Extraction Yield, Total Phenolic Content, and Antioxidant Efficiency of DSE

The prepared DSE was derived through the Soxhlet extraction method with a yield of 36%. The antioxidant activity of DSE is reflected by its TPC value and radical scavenging activity (RSA). The DSE consisted of various phenolic compounds, including phenolic acids, flavonols (such as epicatechin), flavanols (quercetin and its derivatives), and dihydrochalcones (such as phloretin and phlorizin. The TPC and RSA values of the DSE are about 280 mg GAE g⁻¹, and 92%, respectively. However, the yield, TPC, and RSA values of the DSE varied depending on several factors, including date seed variety and extraction methods. Several studies have indicated that oils with the highest polyphenolic content are more resistant to oxidative degradation during deep frying. As a result, high dietary polyphenolic DSE can be considered a significant source of natural antioxidants to boost the antioxidant efficiency of edible oil for deep-frying circumstances.

### LC-MS Analysis

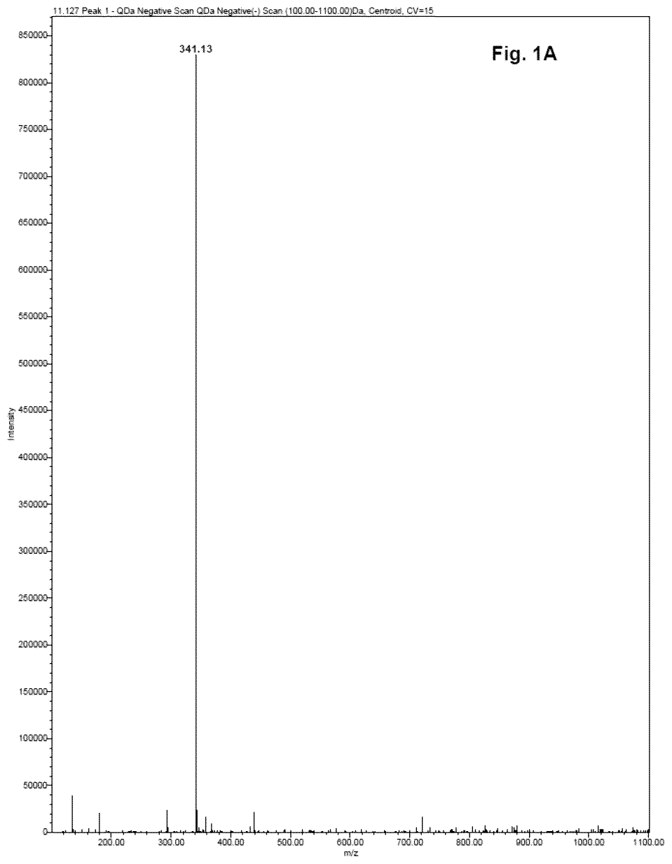

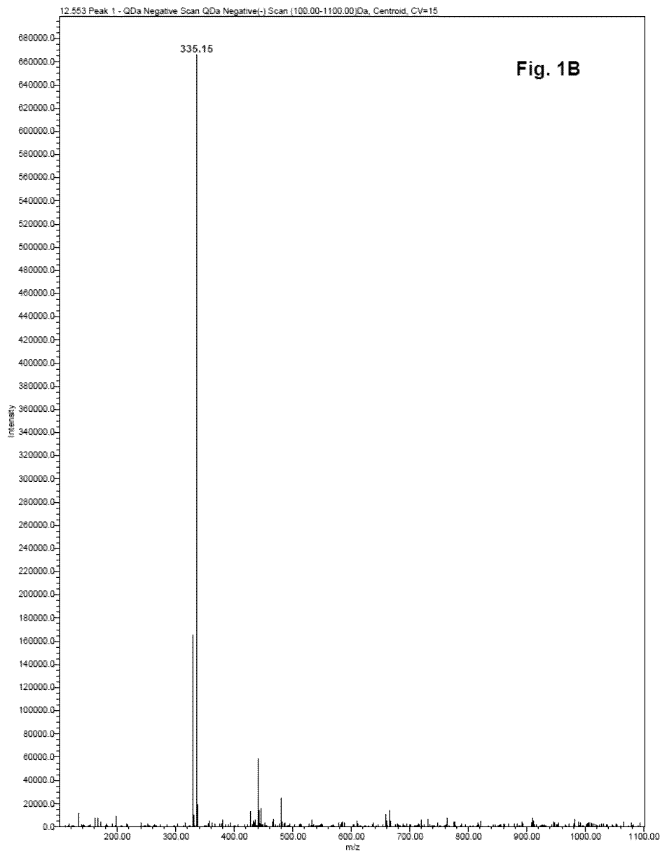

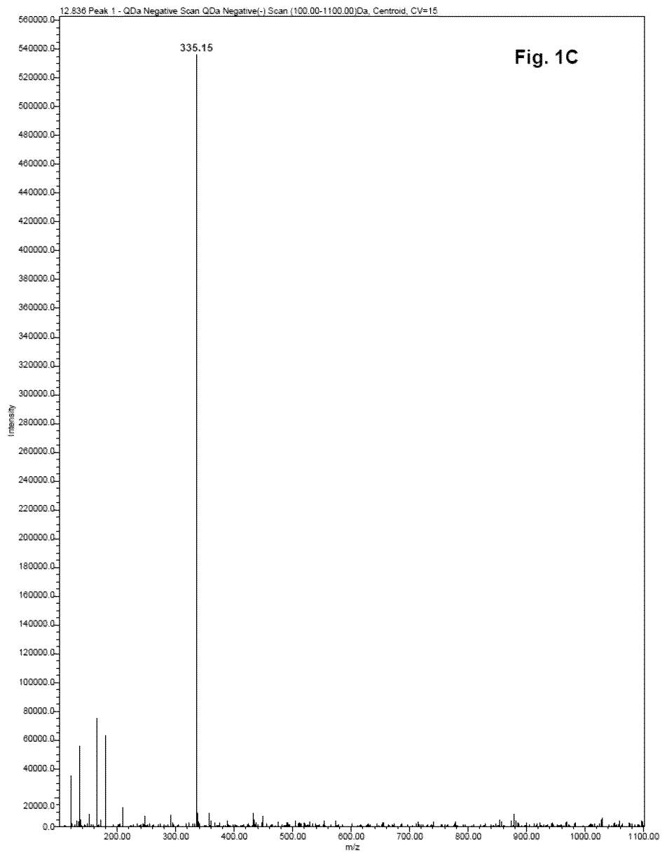

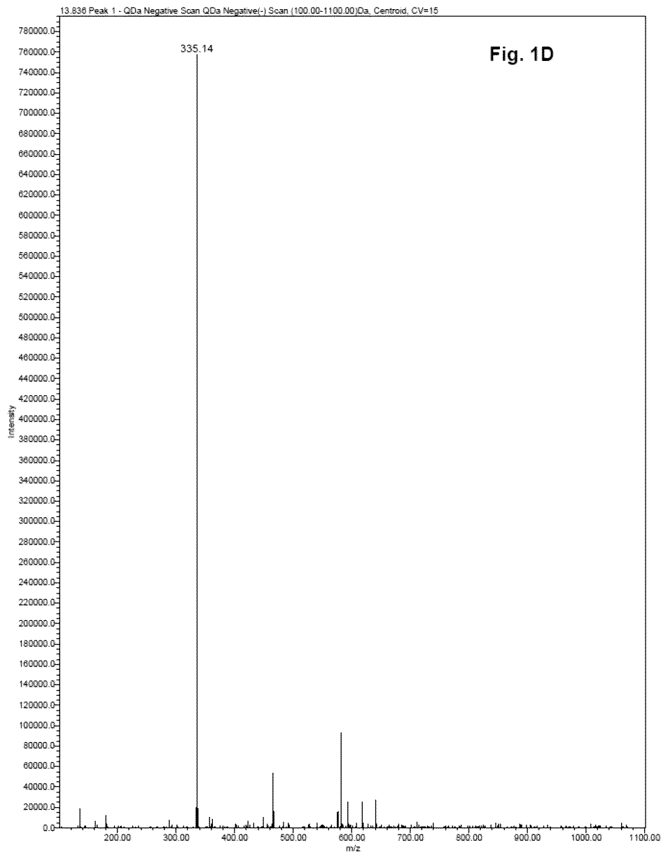

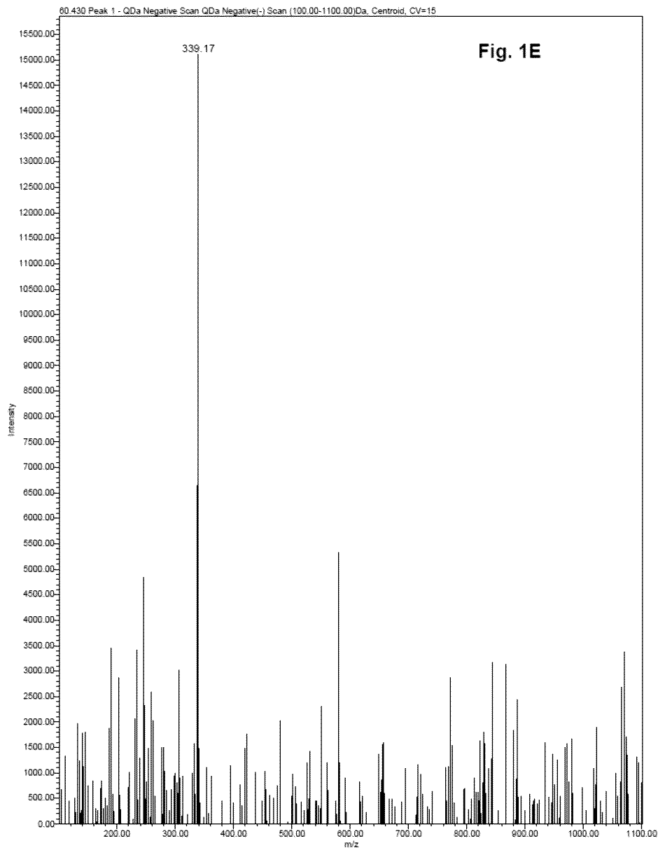

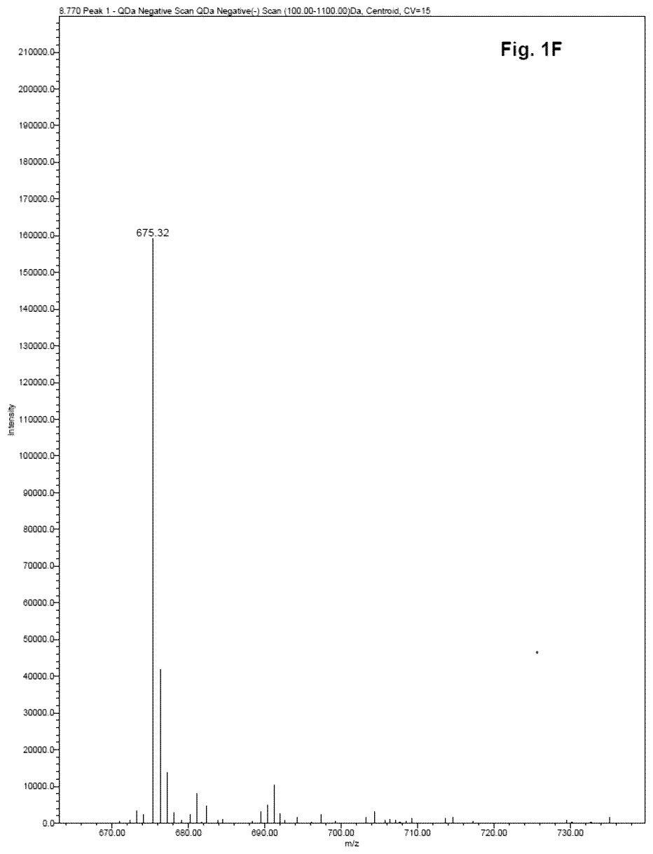

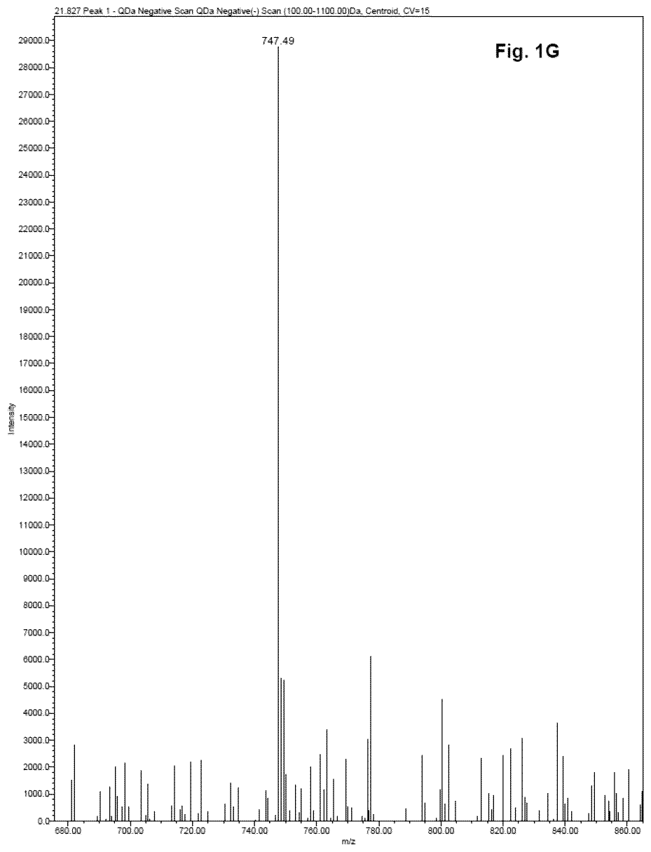

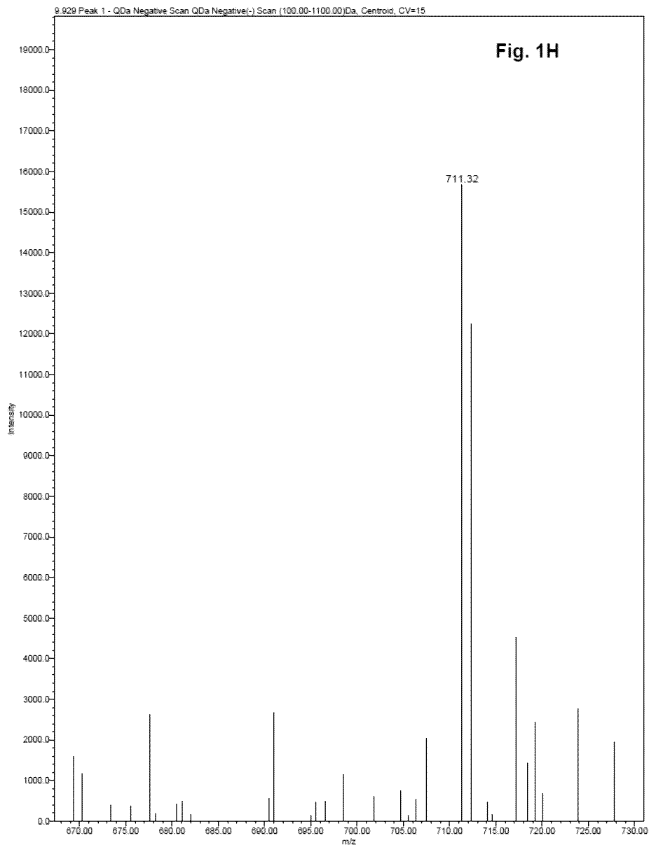

The LC-MS chromatogram derived from DSE revealed a mixture featuring peaks corresponding to phenolic acids, flavonoids, flavones, and proanthocyanidins (monomers, dimers, trimers, and tetramers). A comprehensive analysis led to the identification of thirty-four phenolic compounds and two additional organic acids, accomplished by interpreting fragmentation patterns observed in tandem mass spectra (see Table 1 below). The LC-MS spectra were employed to identify isomers of caffeoylshikimic and coumaroylshikimic acid. Furthermore, the study identified eight conjugated hydroxycinnamic acids with shikimic and quinic acids, five flavan-3-ol derivatives, eight anthocyanidins, and 13 flavonol and flavone derivatives in the DSE (see FIG. 1). The presence of these identified compounds in DSE suggests potential benefits in enhancing the oxidative stability of edible oils and other materials used in food packaging.

TABLE 1
Characterization of polyphenolic compounds in DSE
using LC-MS/MS in negative and positive ions mode.

| | | | | |
|---|---|---|---|---|
| | | | Molecular | [M⁻H]⁻/[ |
| Compound | Retention | | weight | M⁺H]⁺ |
| number | time (RT) | Identified compounds | (Mw) | (m/z) |

Hydroxycinnamates (FIG. 1) m/z (M⁻)

| | | | | |
|---|---|---|---|---|
| 1 (FIG. 1A) | 11.1 | Caffeoyl-O-hexoside | 342 | 341 |
| 2 (FIG. 1B) | 12.5 | 5-O-caffeoylshikimic acid (5-CSA) | 336 | 335 |
| 3 (FIG. 1C) | 12.8 | 4-O-caffeoylshikimic acid (5-CSA) | 336 | 335 |
| 4 (FIG. 1D) | 13.83 | 3-O-caffeoylshikimic acid (5-CSA) | 336 | 335 |
| 5 (FIG. 1E) | 60.4 | caffeoyl-2-hydroxyethane-1,1,2- | 340 | 339 |
| | | tricarboxylic acid | | |
| 6 (FIG. 1F) | 8.7 | Feruloyl-O-p-coumaroyl-O- | 676 | 675 |
| | | caffeoylshikimic acid | | |
| 7 (FIG. 1G) | 21.82 | 3-O-feruloy1-7-O-acyl-feruloyl-4-O- | 748 | 747 |
| | | caffeoyl-quinic acid | | |
| 8 (FIG. 1H) | 9.29 | Tri-caffeoylquinic acid | 712 | 711 |

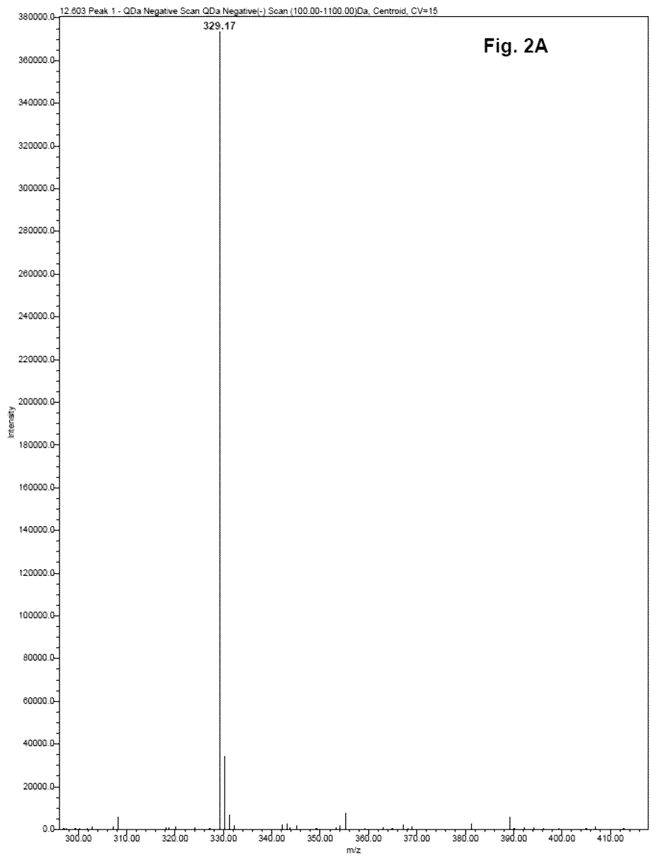

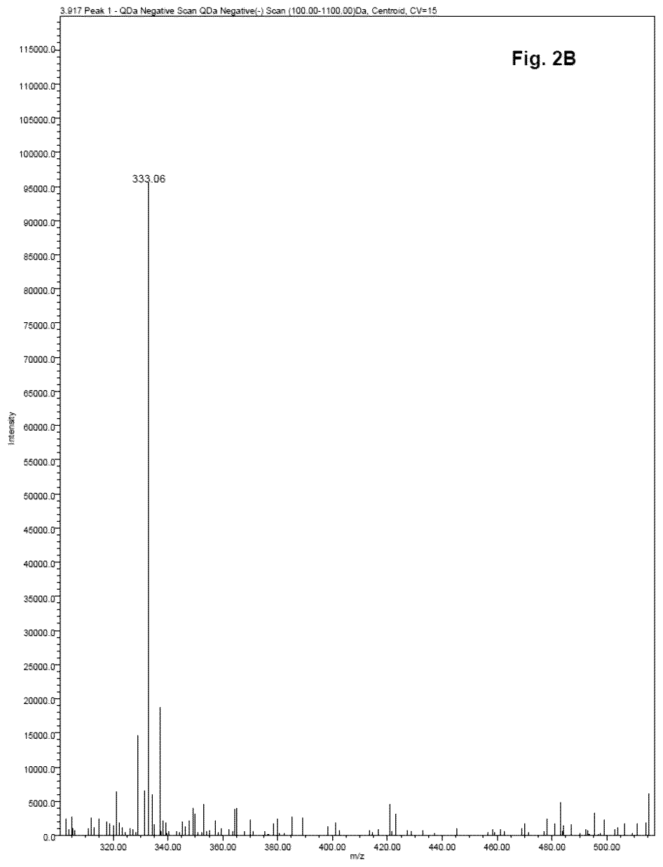

Other organic acids (FIG. 2) m/z (M⁻)

| | | | | |
|---|---|---|---|---|
| 9 (FIG. 2A) | 12.6 | Trihydroxy-octadecanoic acid isomer | 330 | 329 |
| 10 (FIG. 2B) | 3.9 | Trihydroxyoctadecanoic acid sulphate | 334 | 333 |

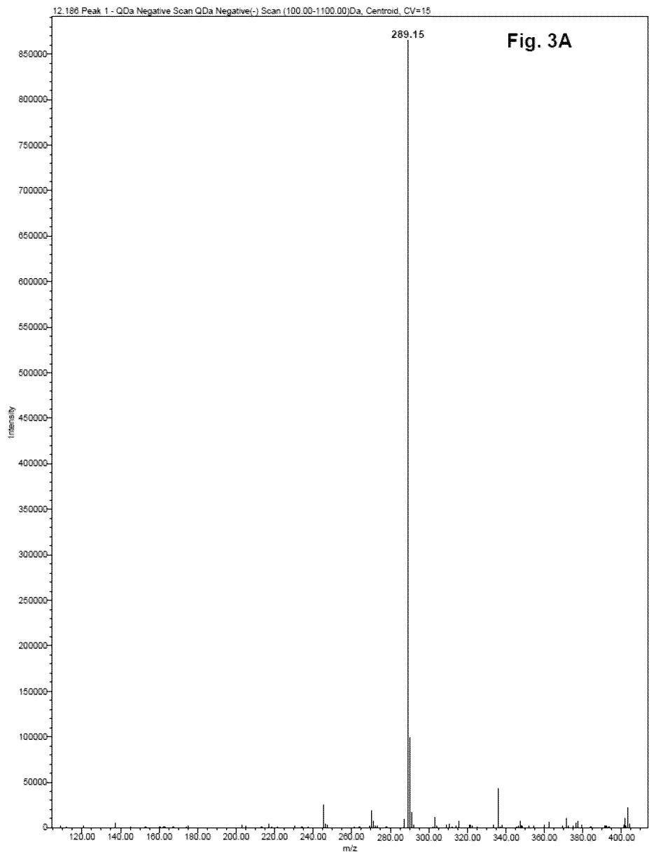

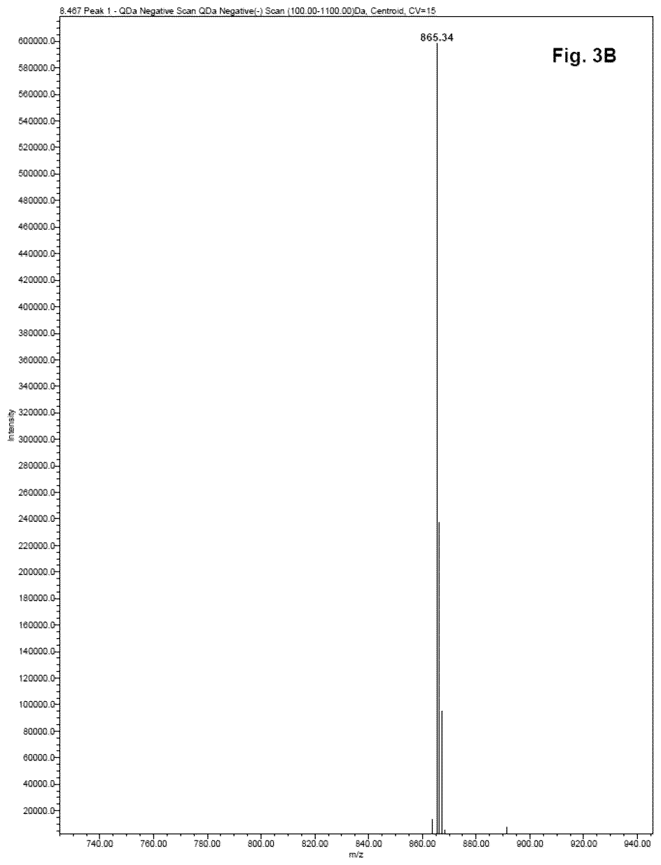

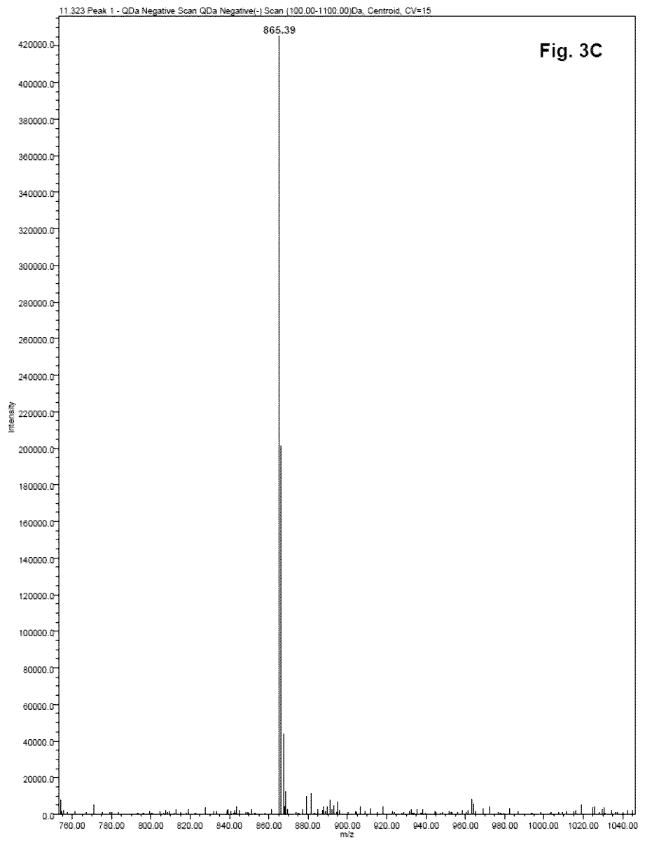

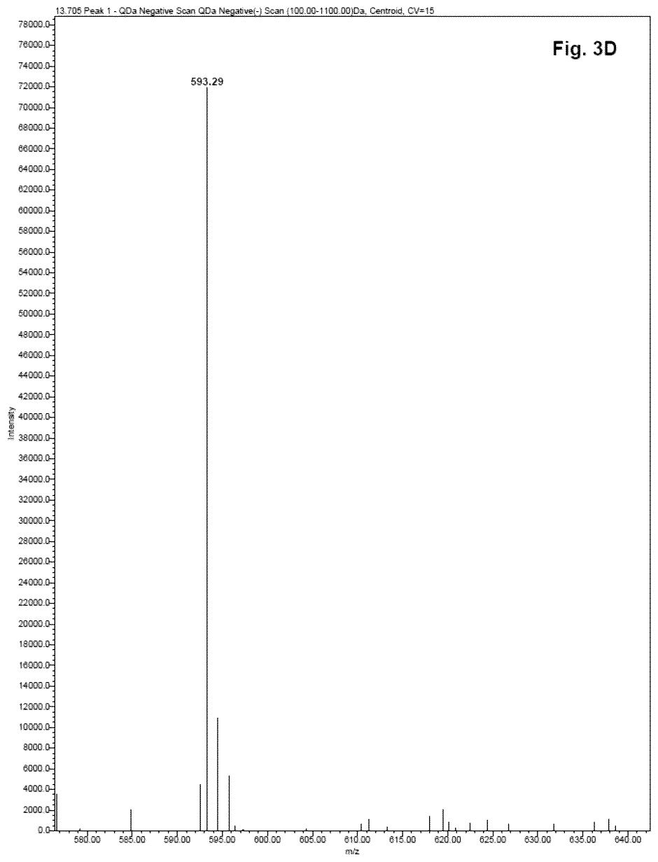

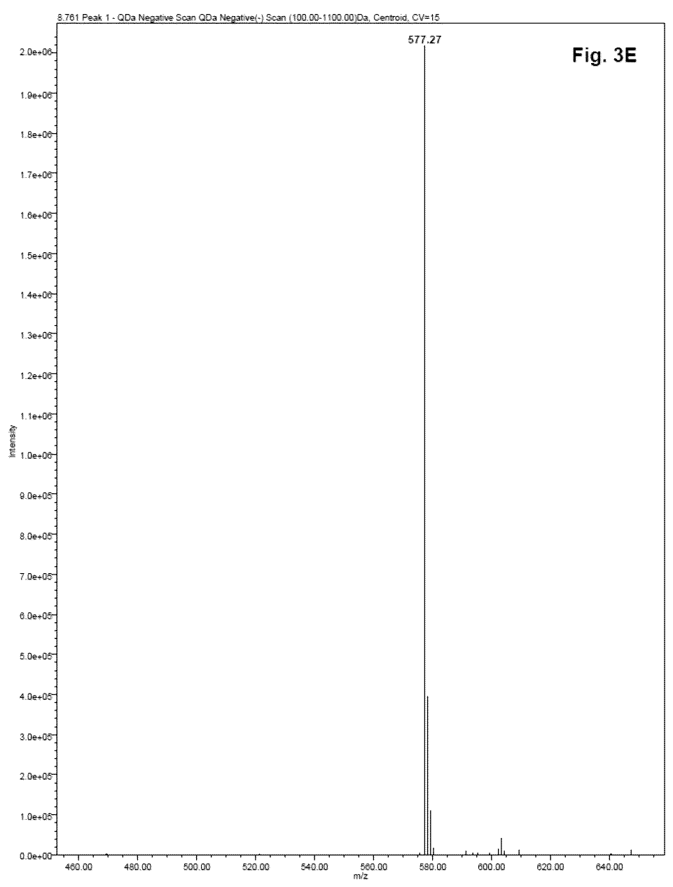

Flavan-3-ols (FIG. 3)

| | | | | |
|---|---|---|---|---|
| 11 (FIG. 3A) | 12.18 | (E)Catechin ^{a} | 290 | 289 |
| 12 (FIG. 3B) | 8.46 | (E)Catechin-(E)Catechin-(E)Catechin ^{a} | 866 | 865 |
| 13 (FIG. 3C) | 11.32 | (E)Catechin-(E)Catechin-(E)Catechin ^{a} | 866 | 865 |
| 14 (FIG. 3D) | 13.7 | (E)Catechin-(E)Gallocatechin ^{a} | 594 | 593 |
| 15 (FIG. 3E) | 8.76 | (E)Catechin-(E)Catechin ^{a} | 578 | 577 |

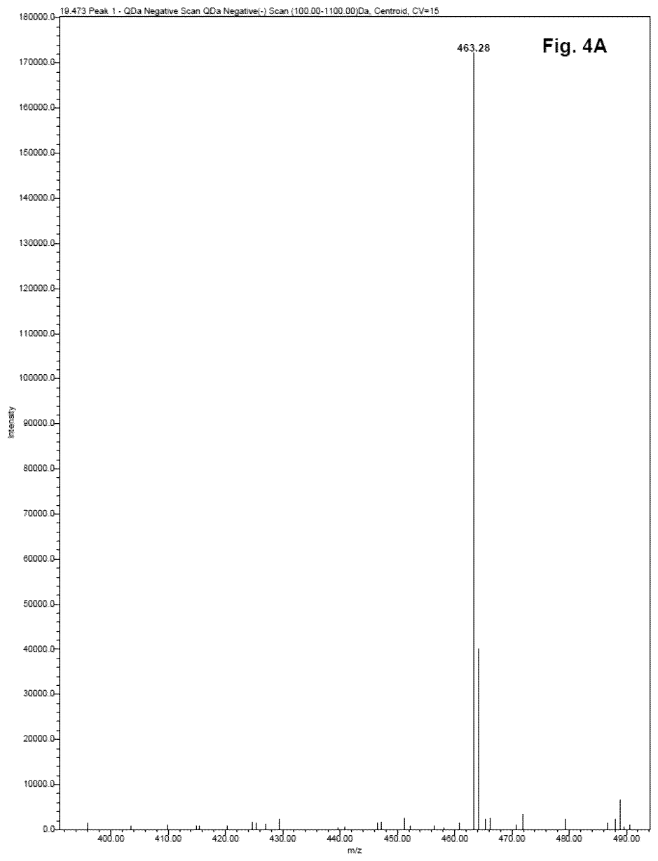

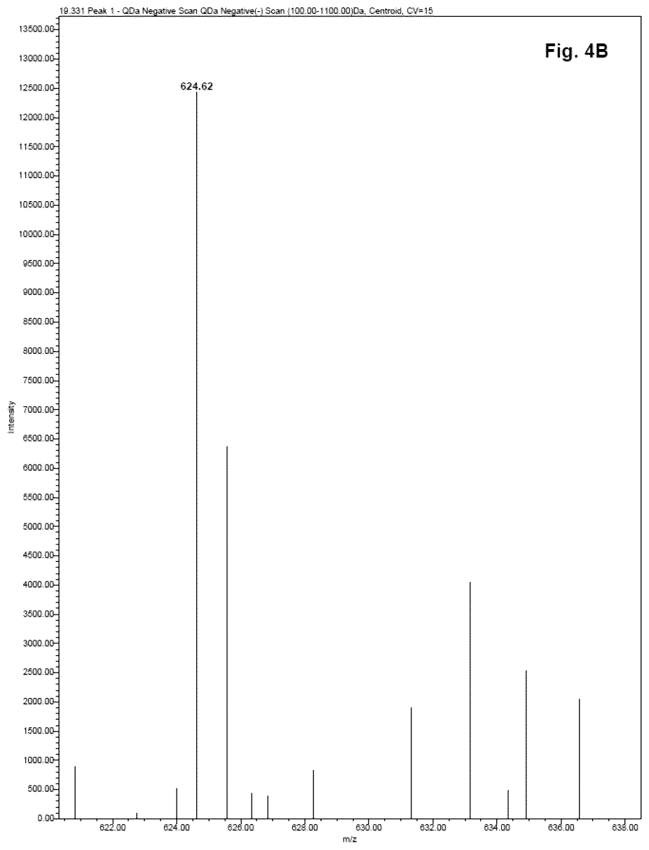

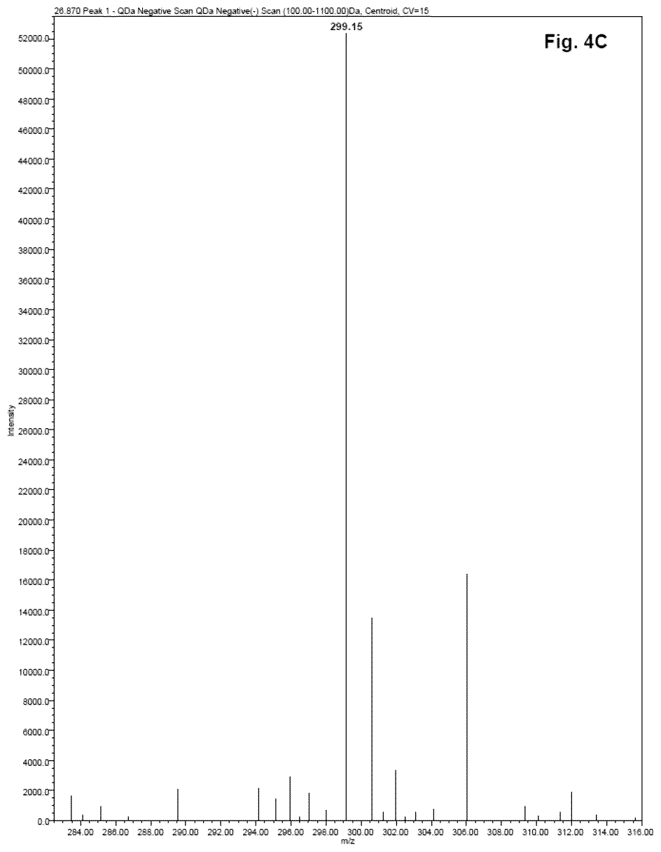

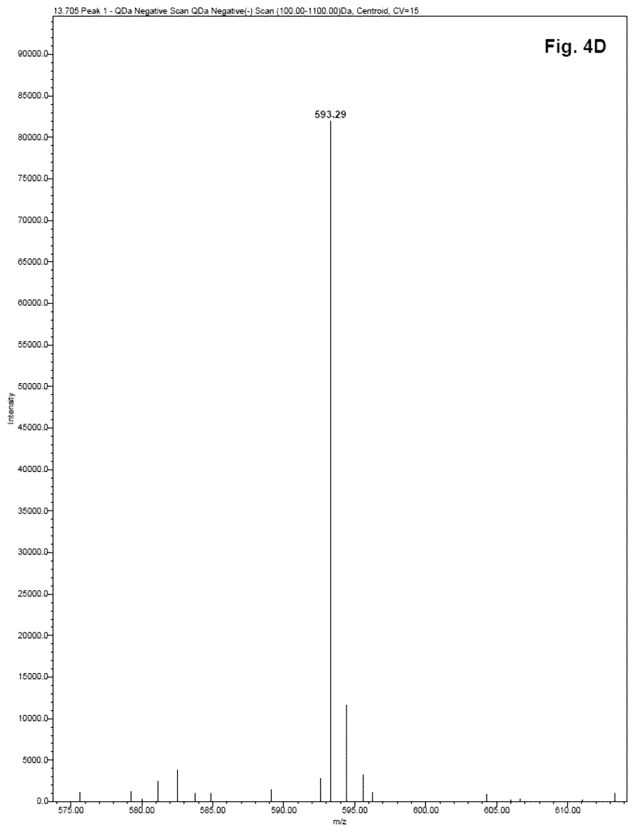

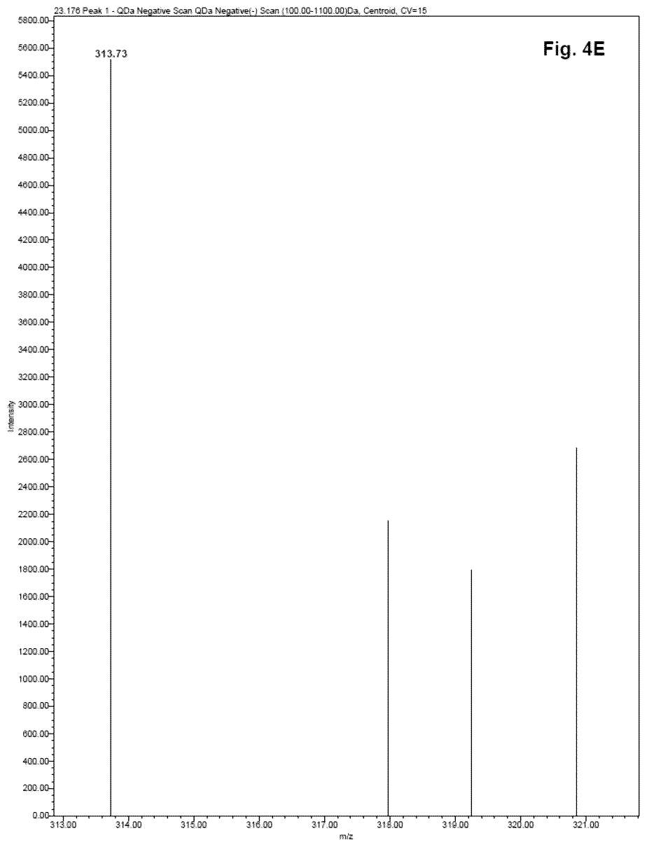

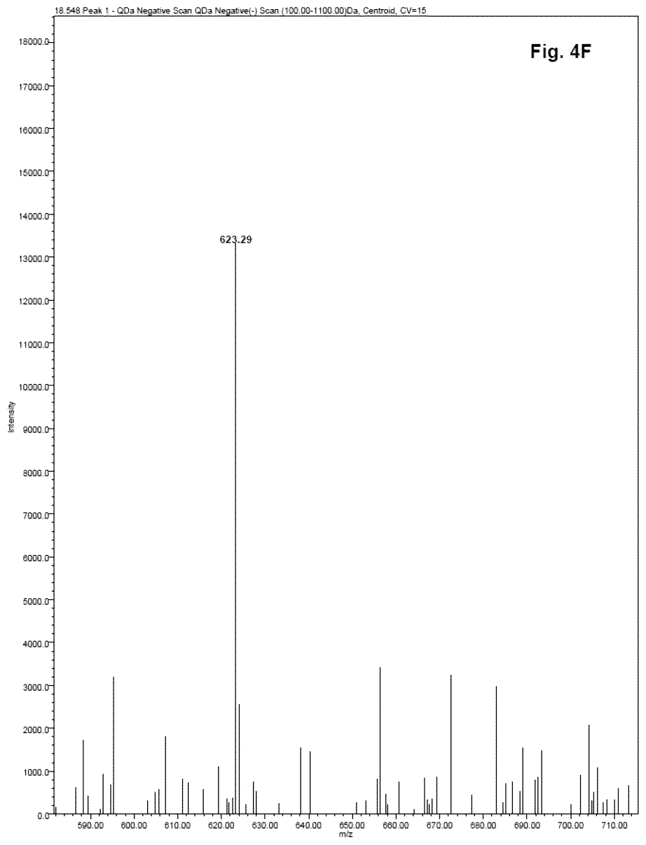

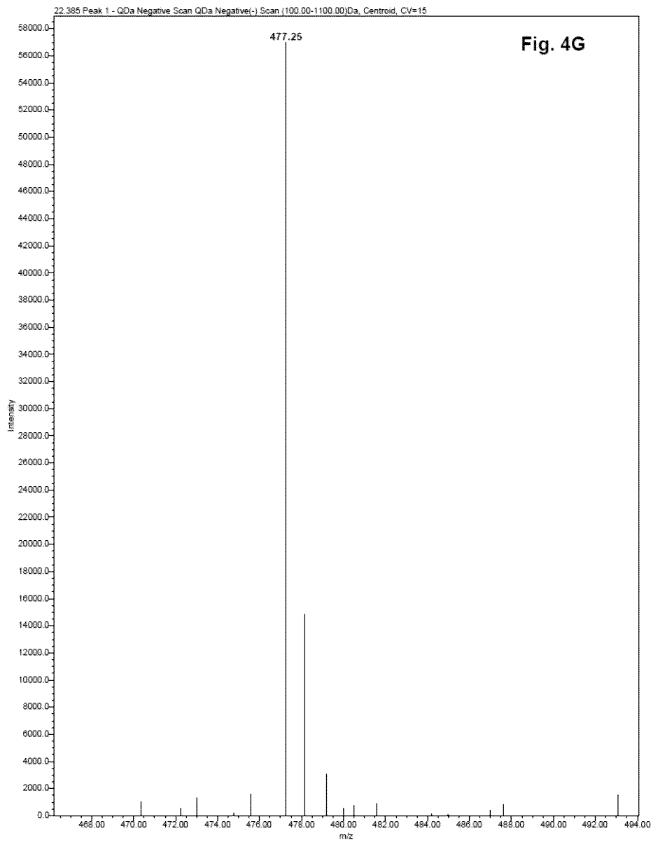

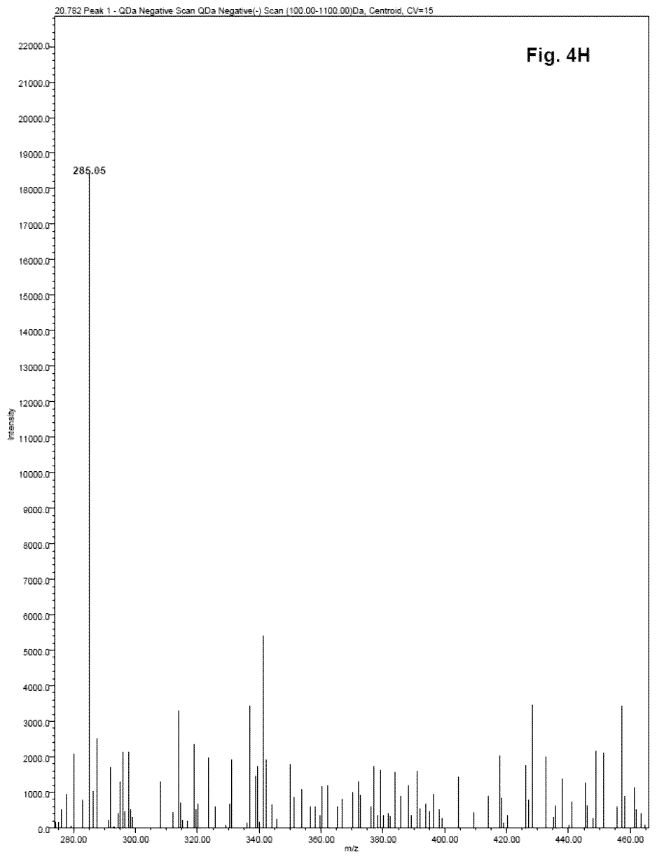

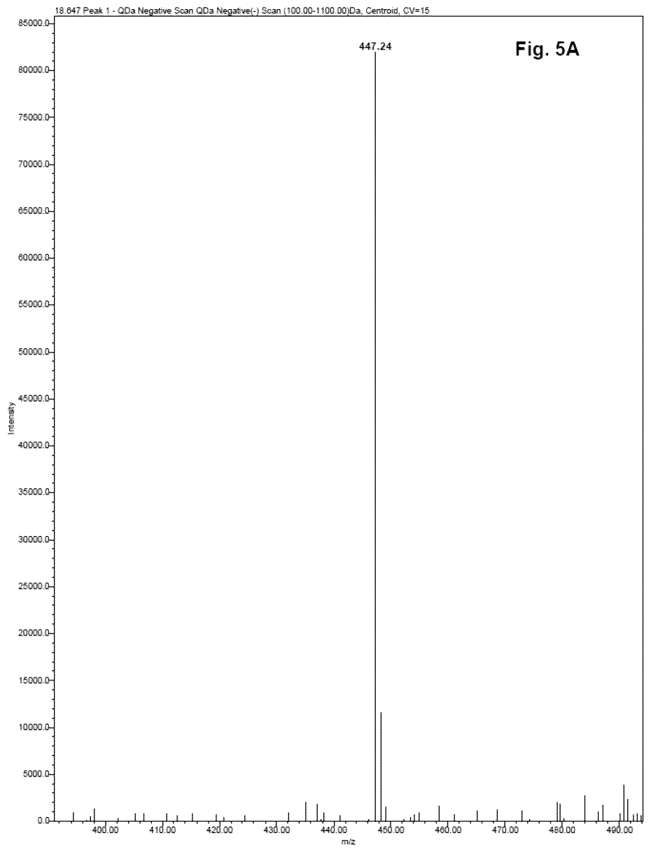

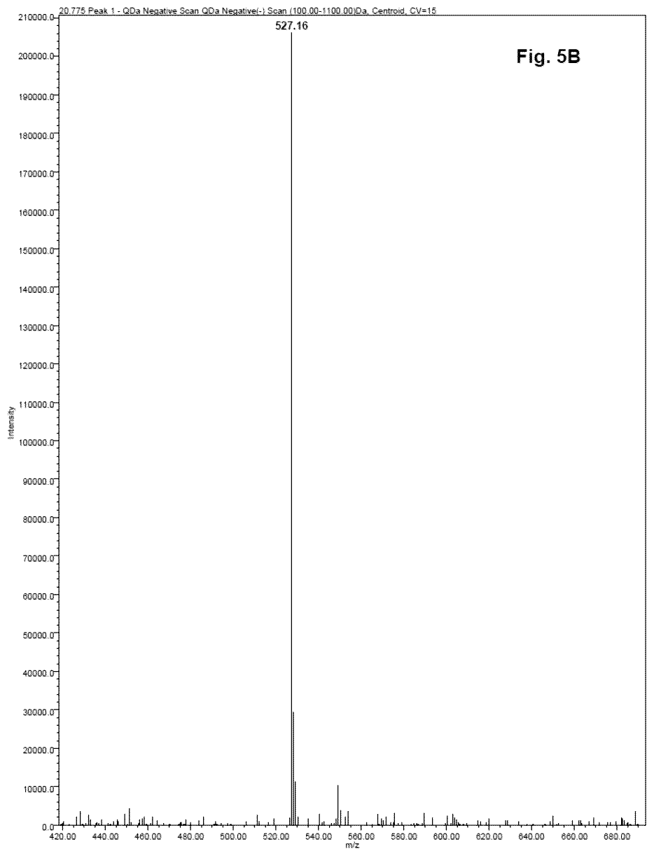

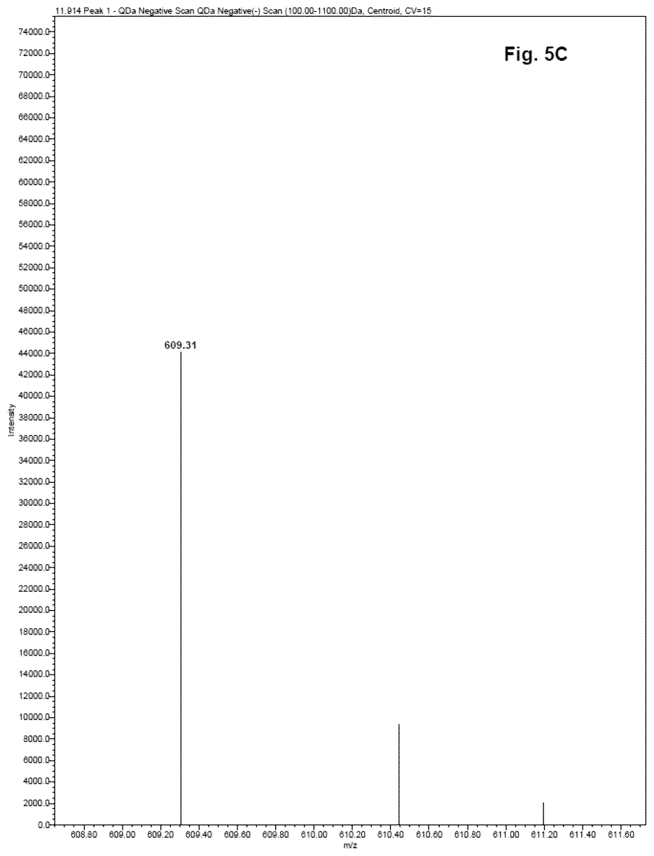

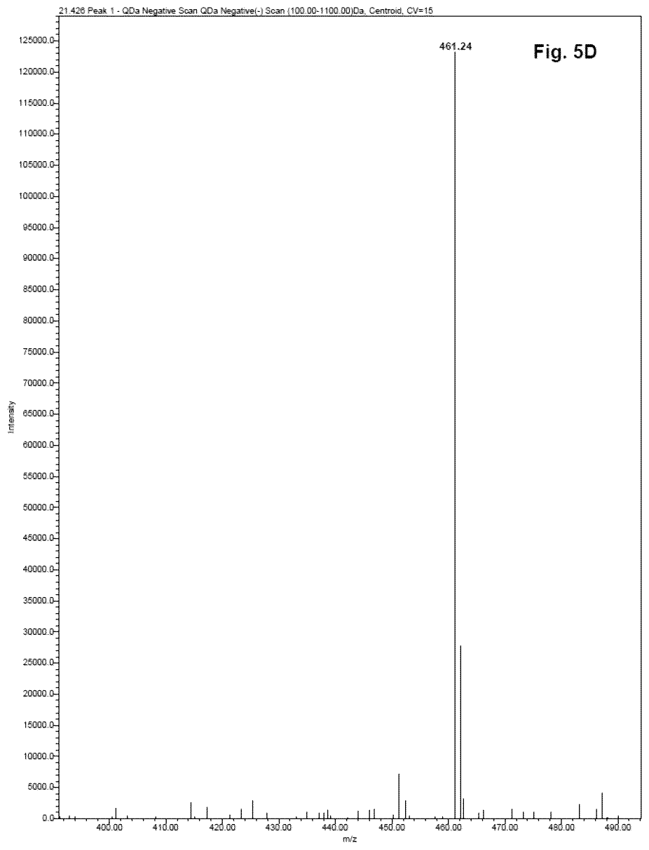

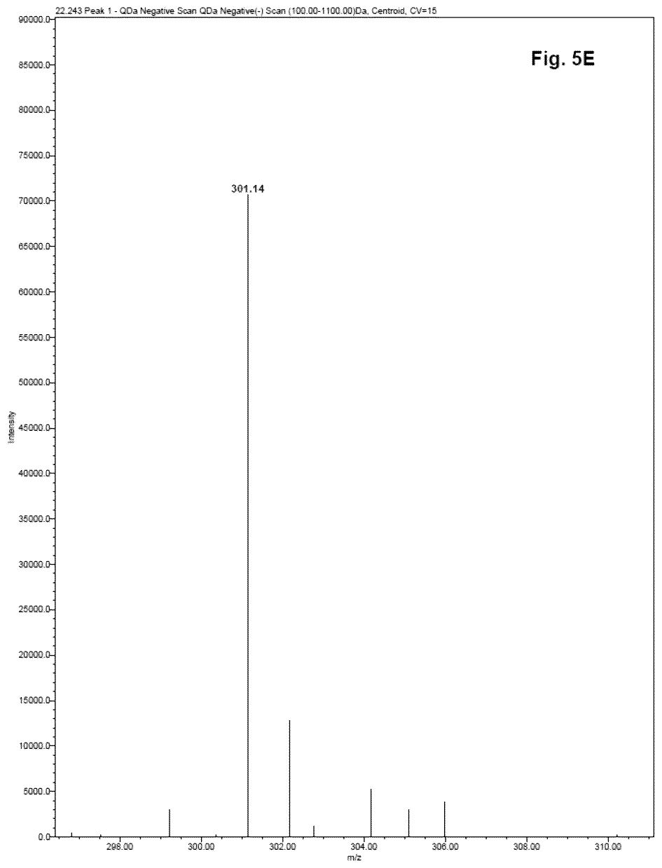

Flavonols and flavones (FIG. 4 and FIG. 5) m/z (M⁻)

| | | | | |
|---|---|---|---|---|
| 16 (FIG. 4A) | 19.47 | Hexosylquercetin | 464 | 463 |
| 17 (FIG. 4B) | 19.33 | Dihexosylquercetin | 626 | 625 |
| 18 (FIG. 4C) | 26.8 | Gliricidin or 3-O-methylorobol | 300 | 299 |
| 19 (FIG. 4D) | 13.7 | Rhamnosylhexosyl luteolin | 594 | 593 |
| 20 (FIG. 4E) | 23.2 | Isorhamentin | 315 | 314 |
| 21 (FIG. 4F) | 18.54 | Rhamnosylhexosyl methyl quercetin | 624 | 623 |
| 22 (FIG. 4G) | 22.4 | Isorhamentin hexoside | 478 | 477 |
| 23 (FIG. 4H) | 20.8 | Kaempferol | 286 | 285 |
| 24 (FIG. 5A) | 18.64 | Orientin or Isoorientin | 448 | 447 |
| 25 (FIG. 5B) | 20.7 | (Orientin or Isoorientin)-sulphate | 528 | 527 |
| 26 (FIG. 5C) | 11.9 | Quercetin rutinoside | 610 | 609 |
| 27 (FIG. 5D) | 21.4 | Chrysoeriol hexoside | 462 | 461 |
| 28 (FIG. 5E) | 22.24 | Quercetin | 302 | 301 |

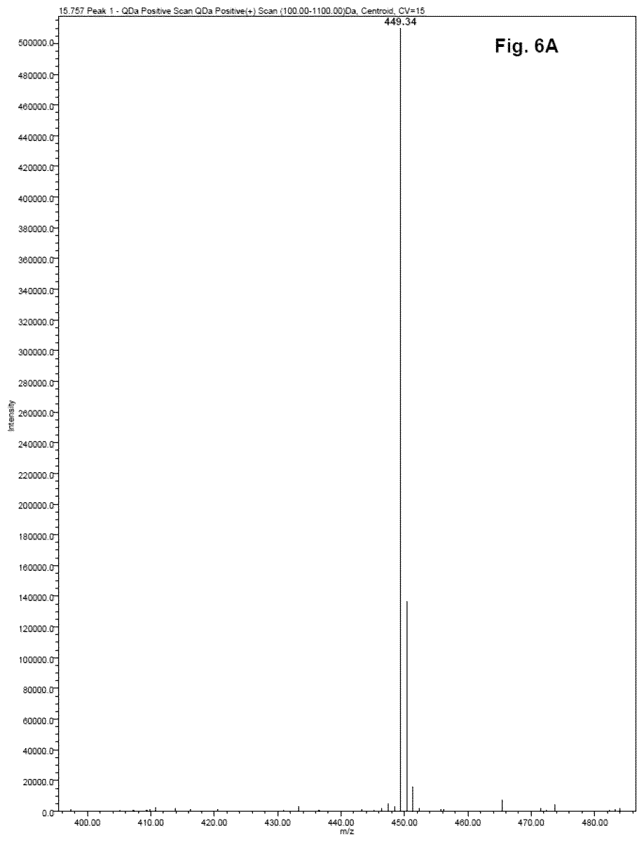

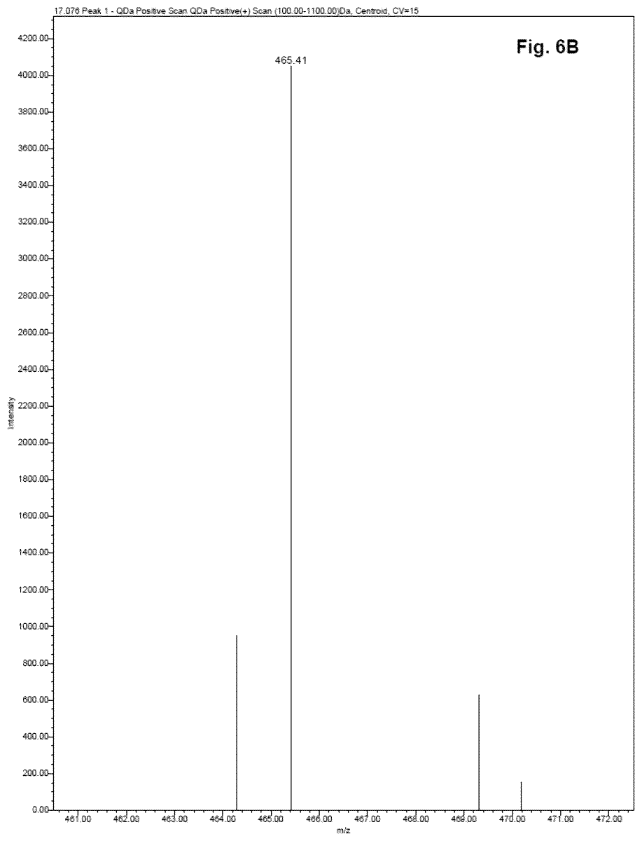

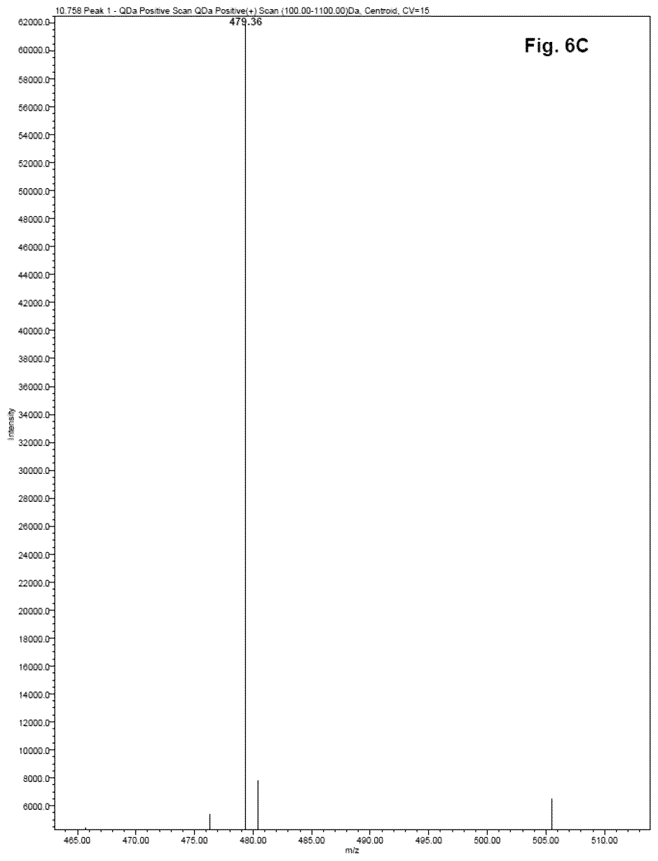

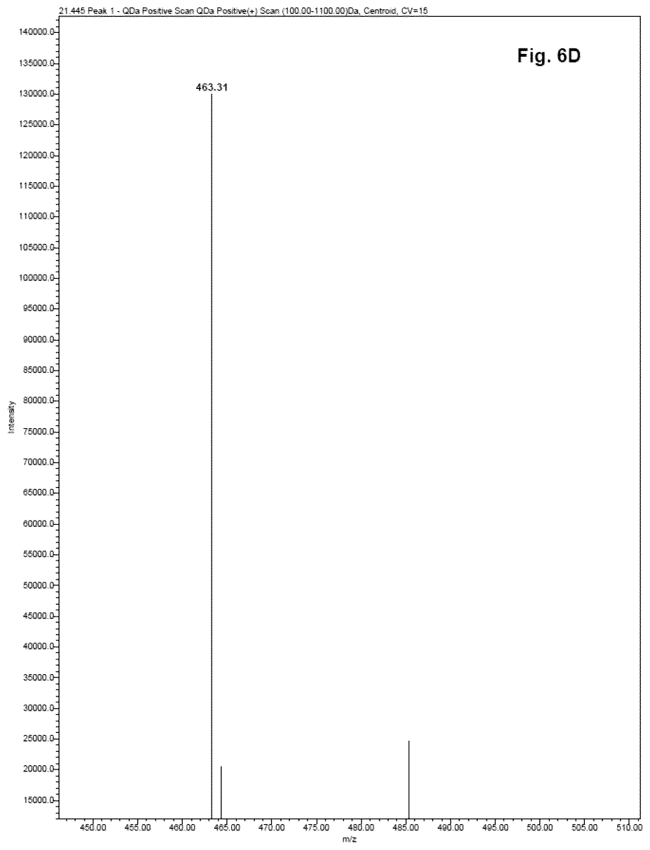

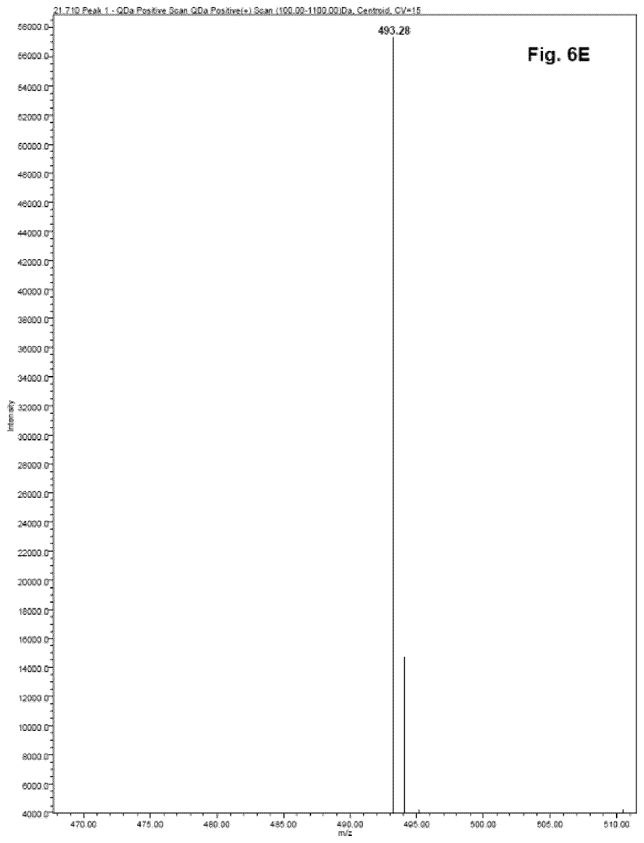

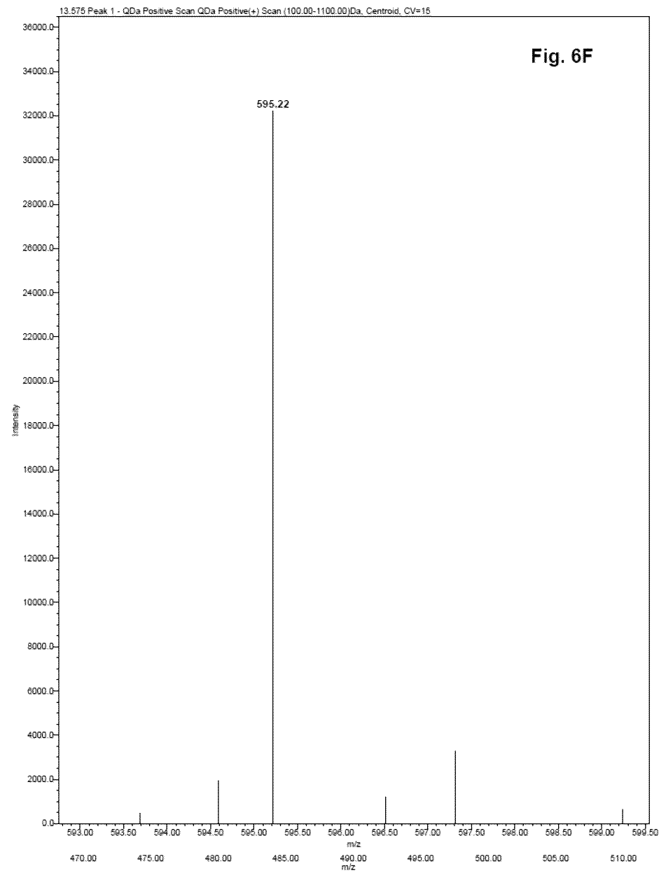

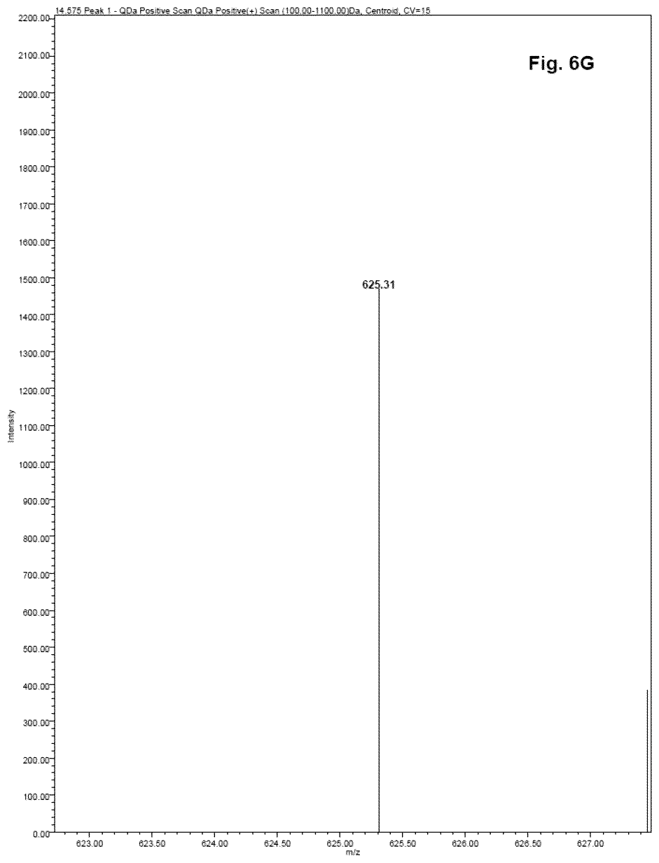

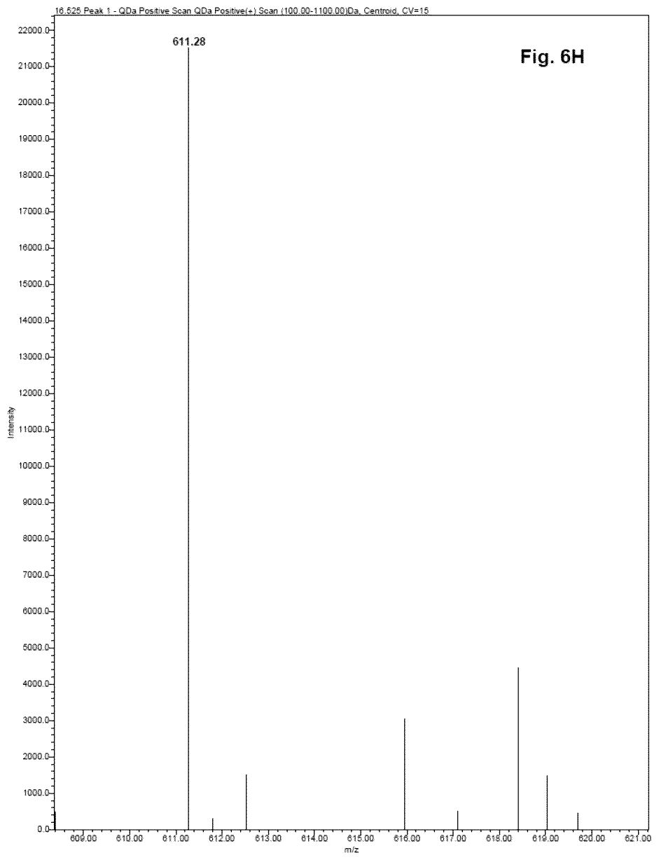

Anthocyanin derivatives (FIG. 6) m/z (M⁺)

| | | | | |
|---|---|---|---|---|
| 31 (FIG. 6A) | 15.75 | Cyanidin 3-O- glucoside | 448 | 449 |
| 32 (FIG. 6B) | 17.07 | Delphinidin-3-O-glucoside | 464 | 465 |
| 33 (FIG. 6C) | 10.75 | Petunidin-3-O-glucoside | 478 | 479 |
| 34 (FIG. 6D | 21.44 | Peonidin-3-O-glucoside | 462 | 463 |
| 35 (FIG. 6E) | 21.71 | Malvidin-3-O-glucoside | 492 | 493 |
| 36 (FIG. 6F) | 13.58 | Cn-3-(6″-p-coumaroylglucoside) | 594 | 595 |
| 37 (FIG. 6G) | 14.57 | Pt-3-(6″-p-coumaroylglucoside) | 624 | 625 |
| 38 (FIG. 6H) | 16.52 | Dp-3-(6″-p-coumaroylglucoside) | 610 | 611 |

^{a} represents there are two possibilities “catechin or epicatechin; gallocatechin or epigallocatechin”

### Acid Value (AV)

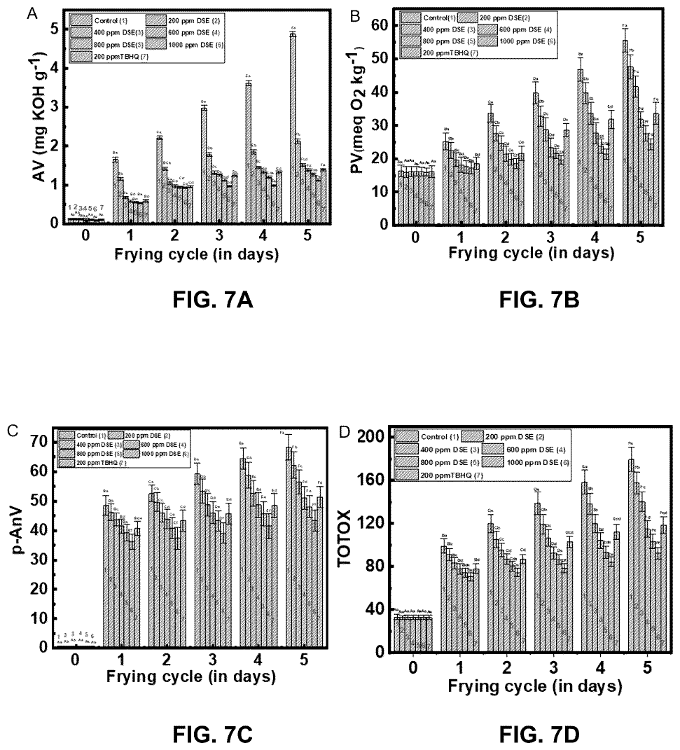

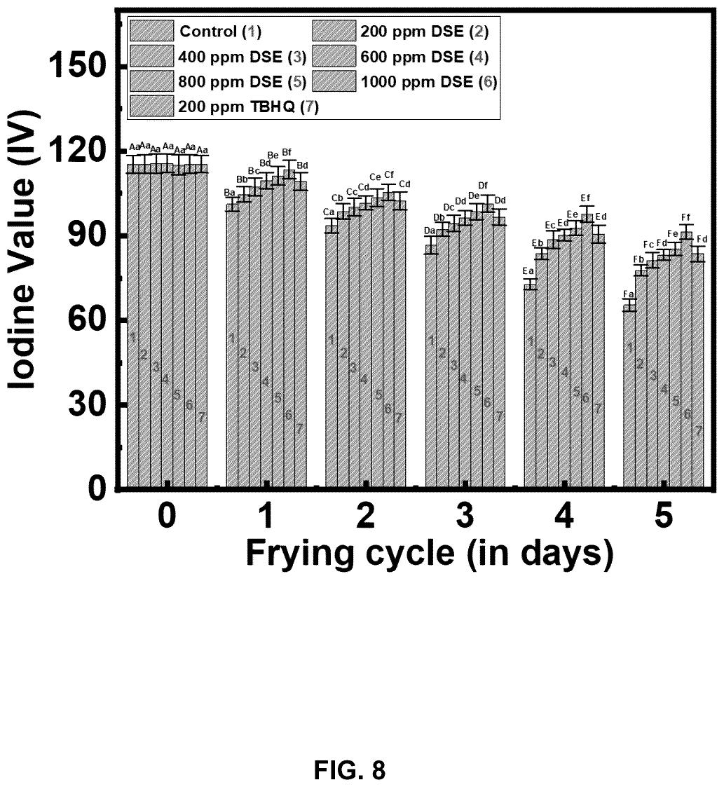

The AV determines the degree of oil degradation caused by triglyceride hydrolysis and hydroperoxide decomposition during the frying process by measuring the free fatty acid concentration of the oil. Also, the AV is one of the significant and reliable parameters for assessing deteriorative changes in oils, including edible oils used for food-frying processes. Although, before the frying process, the control and DSE-enriched oil samples possess almost the same AV range between 0.09 to 0.1. However, the oil's acidity increased gradually concerning the frying time due to the hydrolysis of triglycerides, and the secondary oxidation products turned into free fatty acids. The oil's observed acidity elevated in the last two frying cycles/days (see FIG. 8). Initially, the control sunflower oil exhibited the AV of 0.12 mg. g⁻¹ (day 0), and it reached 2.21 (0.021) and 4.88 mg. g⁻¹ (0.03) for days 2 and 5, respectively, under deep-frying conditions. This indicates that the control sunflower oil substantially deteriorated during the deep-frying cycles due to the rapid oxidation process, with nearly doubled oxidation from the third cycle/day to the fifth cycle/day. In contrast, the DSE-enriched sunflower oil demonstrated a slowed increase in AV during the deep-frying cycles concerning the DSE content in the oil. For instance, after the 5^{th} day of deep-frying, the 800 ppm DSE enriched oil possesses a lower AV of 1.26(±0.04), demonstrating that the higher DSE content suppressed the hydrolysis reaction during the deep-frying process. Also, the AV increases from 0.12(±0.02) to 4.88(±0.06), 0.09(±0.01)-1.39(±0.02), and 0.09(±0.01)-1.12(±0.03) mg g⁻¹ for the control sunflower oil, 200 PPM TBHQ loaded oil, and 1000 PPM DSE loaded oil, respectively, for day-5 deep frying process (see FIG. 7A). Thus, the lower degree of hydrolysis reaction observed during the potato-frying cycles of sunflower oil demonstrated the following order of DSE>TBHQ>control. These results may indicate that natural antioxidants of DSE act as better-stabilizing agents in edible, frying oil than synthetic antioxidants.

### Peroxide Value (PV)

The PV is one of the most widely employed test methods to measure the primary oxidation products, including peroxides and hydroperoxides in edible oils, which are taken as representing the oil's quality. A lower PV may indicate a higher oxidative stability of the oil. The oil undergoes autoxidation during the high-temperature frying process. As a result, the principal oxidation products of hydroperoxides were unstable and decomposed into numerous tiny molecules, ultimately resulting in the edible oil becoming rancid. The influence of antioxidants during a frying process on PV in the sunflower oil samples is shown in FIG. 7B. Before frying, the control sunflower oil and DSE-enriched oil samples show a PV of around ≤16 mEq O₂ kg. When the frying time was increased from cycle/day 0 to cycle/day 5, as-generated peroxides in the oil sample were unstable, which turned into secondary oxidation metabolites. The PV of the DSE-enriched oil samples was lower than the control when the frying cycles were extended. Furthermore, the polyphenolic compounds in DSE may act as a radical acceptor in the sunflower oil, terminating the oxidation reaction and resisting forming of new radicals during the initial stage. Hence, the DSE-enriched oil may prolong the initial oxidation stage in the frying process, showing a slower increase in PV of the fried oil samples. The sunflower samples that were loaded with a higher DSE content showed a lower PV during the frying cycles, indicating that the natural antioxidant of DSE may slow down the oxidation process, resulting in a slower rise in PV.

The 800 ppm DSE-loaded oil sample (27.61±2.3 meq O₂/kg) demonstrated a lower PV than the 200 ppm THBQ-loaded oil samples (33.60±3.3 meq O₂/kg) after the 5^{th}-day frying cycle. This may indicate that the complex phenolic compounds in DSE were stable at high-temperature, protecting the autoxidation of primary oxidation products during the frying process than synthetic oxidants, as can be degraded in just a few frying cycles.

p-Anisidine Value (p-AnV)

During the frying process, the hydroperoxides rapidly break down and transform into stable unsaturated alpha and beta aldehydes and ketone derivatives, destroying the oil's color and odor. Furthermore, the p-AnV determines the oil's secondary oxidation stage and is a primary method for determining the oxidation degree of frying oil. Generally, intense natural pigments or specific flavorings or carotenoid color compounds in the oil samples interfere with the p-AnV. Indeed, the DSE-enriched sunflower oil exhibits little intense color than the pure oil concerning the DSE content due to the natural anthocyanin pigment in DSE. However, the oil's color hasn't changed much after deep frying, as evidenced by their colorimetric values (see Table 3). The initial (day 0) p-AV for pure oil of 0.60±0.05, and DSE enriched oils around 0.6-0.64±0.07, which are less than the standard acceptable limit of 10. DSE-enriched oil exhibits a slow increase in p-AV than the control oil, indicating that adding antioxidants to frying oils enhances their thermo-oxidative stability. The p-AnV of the pure and DSE-enriched samples increased concerning the frying cycle (p<0.05), and the DSE inhibitory efficiency varied depending on its concentration in the oil. After 5^{th} day of the frying process, DSE-800 ppm enriched oil showed a lower p-AnV (48.1±3.7) than the 200 ppm THQB loaded oil sample (51.4±3.6) (p<0.05). This suggests that the natural antioxidant-enriched oil efficiently inhibits the formation of secondary oxidation products than the synthetic oxidant in a permissible limit (see FIG. 7C). After 5^{th}-day frying, the highly DSE enriched (1000 ppm) oil exhibiting the lower p-AnV of 43.4±3.6 than 200 ppm TBHQ-loaded oil sample (51.4±3.6), indicating that the natural antioxidant of DSE helps to slow down the accumulation rate of secondary oxidative products of aldehydes and ketones in the oil sunflower oil.

### TOTOX Value

The total oxidation value theoretically estimates the oil's oxidative stability by calculating the oxidation values of primary and secondary products from PV and p-AnV. After the deep-frying process, the pure oil exhibits a higher TOTOX value than its initial value, even after the first-day frying cycle. Further, the TOTOX value of pure oil was substantially increased with an increase in the frying process. On the other hand, the DSE-enriched oil reduced the oxidation of sunflower oil during the frying process, resulting in a modest rise in TOTOX value concerning DSE content in the oil. Furthermore, the 600 ppm DSE enriched sunflower oil (114.7±7.8) showed an almost equal TOTOX value of 200 ppm TQHB incorporated oil (118.6±7.6) on the 5^{th} day of the frying conditions (FIG. 7D). In addition, the 1000 ppm DSE-enriched oil shows the lowest TOTOX value (92.2±5.2) compared to the TBHQ loaded sunflower oil, indicating DSE's potential antioxidant activity during the frying conditions.

### Iodine Value (IV)

The iodine value represents the degree of unsaturated level in edible cooking oils. During the frying process, the heated oil causes rancidity, affecting the double bonds of unsaturated fatty acids and decreasing the IV. Furthermore, sunflower oil consists of a high amount of linoleic polyunsaturated fatty acid, which converts into saturated acid during the continuous frying conditions. FIG. 8 shows the iodine value of DSE, TBHQ, and control samples during the frying cycle from day 0 to day 5. The IV of the oil samples decreased gradually with the increases in frying cycles. In particular, the IV was significantly reduced for the control oil sample even after the first frying cycle. However, the IV of the DSE-enriched oil samples shows a slight decrease in the IV concerning the DSE content in the oil. After 5-day frying cycle, the IV of the oil samples can be reflected in the magnitude of order of: control>DSE-200 ppm>DSE-400 ppm>DSE-600 ppm>TBHQ-200>DSE-800>DSE-1000. As a result, the sunflower oil enriched with above 600 ppm of DSE extract was higher than the TBHQ loaded sample at the end of the 5-day frying cycle. This may indicate that the DSE restricted double reductions during the frying process.

### Total Polar Compounds

Total polar compounds (TPC) analysis determined the amount of polar compounds in fried edible oil, which reflects the quality and degradation level. TPC measures monoglycerides, diglycerides, and free fatty acids that occur naturally in fats or during hydrolytic frying. According to the National Safety Standard for Vegetable Oil (GB 2716-2018), the maximum acceptable TPC content limit for the life of frying oil is known to be about 27%. TPC percentage increased as oil frying duration increased; however, in terms of DSE content, TPC values differ for DSE-enriched oil samples (see Table 2). After two frying cycles, the control oil showed a higher TPC level than the TBHQ and DSE-enriched oil. In contrast, the DSE-enriched oil exhibited a lower TPC with an increase in the content of DSE regardless of the frying cycle. After five deep-frying cycles, the TPC for oil treated with different concentrations of DSE were found to be 26.85, 14.14, 8.28, 6.75, 4.65, and 3.27% for control, 200, 400, 600, 800, and 1000 ppm, respectively. The decrease in the TPC value of the edible oil samples appeared to be dependent on the DSE concentration therein; for instance, 1000 ppm DSE-enriched oil had a lower TPC of 3.27%. The antioxidant compounds in the DSE may limit the formation of polar substances during the frying condition within their accessible limit, resulting in lower TPC values. In addition, the 600 ppm DSE-sunflower oil showed almost equal TPC with TQHB (200 ppm) (6.56%) edible oil sample under similar frying conditions.

TABLE 2
Total polar content (%) of sunflower oil with different
concentrations of DSE (ppm) during the frying process at 180° C.
Frying cycle (in days)

| | 0 | 1 | 2 | 3 | 4 | 5 |
|---|---|---|---|---|---|---|
| Control | 3.98 (±0.55) ^{Aa} | 5.62(±0.55) ^{Ab} | 8.33(±0.82) ^{Ac} | 14.19(±2.55) ^{Ad} | 19.88(±4.55) ^{Ae} | 26.85(±7.55) ^{Af} |
| 200 ppm | 3.32(±0.46) ^{Ba} | 4.96(±0.47) ^{Bb} | 6.94(±0.67) ^{Bc} | 8.75(±0.75) ^{Bd} | 10.55(±0.92) ^{Be} | 14.14(±2.65) ^{Bf} |
| DSE | | | | | | |
| 400 ppm | 3.12(±0.37) ^{Ba} | 4.04(±0.41) ^{Cb} | 5.11(±0.49) ^{Cbc} | 6.72(±0.63) ^{Ccd} | 7.51(±0.55) ^{Cd} | 8.28(±0.77) ^{Cde} |
| DSE | | | | | | |
| 600 ppm | 2.75(±0.33) ^{Ca} | 3.88(±0.54) ^{Cbc} | 4.75(±0.43) ^{Dc} | 5.25(±0.51) ^{Dcd} | 6.02(±0.55) ^{Dd} | 6.15(±0.65) ^{Dd} |
| DSE | | | | | | |
| 800 ppm | 2.45(±0.32) ^{Da} | 2.78(±0.34) ^{Dab} | 3.12(±0.35) ^{Eb} | 3.75(±0.48) ^{Ebc} | 4.12(±0.55) ^{Ec} | 4.65(±0.58) ^{Ecd} |
| DSE | | | | | | |
| 1000 ppm | 2.22(±0.30) ^{Ea} | 2.58(±0.35) ^{Eab} | 2.78(±0.33) ^{Fbc} | 2.92(±0.38) ^{Fbc} | 3.05(±0.55) ^{Fcd} | 3.27(±0.43) ^{Fcd} |
| DSE | | | | | | |
| 200 ppm | 2.65(±0.35) ^{Ca} | 3.8(±0.53) ^{Cb} | 4.55(±0.42) ^{Dbc} | 5.12(±0.51) ^{Dc} | 5.93(±0.55) ^{Dcd} | 6.56(±0.58) ^{Dd} |
| TBHQ | | | | | | |

Means ± standard error within a column with the same uppercase letters is not significantly different at p < .05. Means ± standard error within a row with the same lowercase letters is not significantly different at p < 0.05

### Effect of DSE on the Color of Oil During Deep-Frying Conditions

The colour of edible oil may change from yellow to brown during a food-frying process. This colour change may be due to the accumulation of various non-volatile decomposition products like oxidized triacylglycerols and free fatty acids (FFA) formed during the various chemical reactions that occur, such as oxidation, polymerization and the like. Before frying, the control sunflower oil sample consisted of L*, a*, and b* values of 70.33±2.96, −2.33±0.19, 4.65±0.05, respectively. After introducing DSE, the color values of the oil samples varied slightly. The L* value (brightness/darkness) of the oil falls during frying, whereas the a* (redness/greenness) and b* values (yellowness/blueness) also increased during the frying cycles. The L* value drops from 70.33 to 59.11 (control), 69.56 to 60.23 (200 ppm DSE), 69.13 to 62.05 (400 ppm DSE), 68.75 to 63.23 (600 ppm DSE), 68.16 to 64.28 (800 ppm DSE), 67.76 to 64.41 (1000 ppm DSE), and 70.2 to 63.41 (200 ppm TBHQ) as frying duration increases from 0 to the 5^{th} cycle/day. As demonstrated in the 5^{th}-day frying cycle, 1000 ppm DSE enriched oil still had a superior L* value compared to the other samples, which may indicate a slower rate of oil degradation. Furthermore, the observed increases in a* and b* values during frying may be due to the partial oxidation of the edible oil, resulting in the formation of chroman-5,6-quinone followed by the reaction with the metal ions during the frying process. The control sample rapidly increased a* and b* values during the 0-5th-day frying cycle, which can be attributed to the fast breakdown of oxidation products under the frying conditions. These results were in positive correlation to the peroxide value. The DSE-enriched oil samples demonstrated a slower increase in a* and b* values from the 0-5^{th}-day frying cycle. In addition, the 600 ppm DSE-loaded sample exhibited almost the same a* and b* values of the 200 ppm TQBH loaded sample at the 5^{th}-day frying condition. The change in color parameters (L*, a*, and b* values) of control and DSE-enriched oil samples are shown in Table 3. As compared to control oil, the natural antioxidant of DSE effectively stabilized the edible oil's color by preventing the metal ions formation and minimizing oxidation during deep-frying condition.

TABLE 3
L*, a*, and b* color values of frying oil samples.

| | Frying cycle | | | |
|---|---|---|---|---|
| | (in days) | L* | a | b % |
| Control | 0 | 70.33(±2.96) ^{A} | −2.33(±0.07) ^{a} | 4.65(±0.05) ^{a} |
| | 1 | 68.84(±2.33) ^{B} | −1.62(±0.06) ^{b} | 13.65(±0.04) ^{b} |
| | 2 | 66.45(±2.02) ^{C} | 0.94(±0.08) ^{c} | 21.65(±0.16) ^{c} |
| | 3 | 64.75(±2.35) ^{D} | 1.18(±0.05) ^{c} | 33.65(±0.25) ^{d} |
| | 4 | 62.05(±1.98) ^{E} | 1.72(±0.05) ^{d} | 44.51(±0.18) ^{e} |
| | 5 | 59.11(±2.55) ^{F} | 2.33(±0.06) ^{e} | 53.68(±0.36) ^{f} |
| 200 ppm | 0 | 69.56(±2.96) ^{a} | −1.85(±0.07) ^{a} | 5.25(±0.07) ^{a} |
| DSE | 1 | 68.62(±2.96) ^{a, b} | −1.22(±0.05) ^{b} | 10.65(±0.09) ^{b} |
| | 2 | 66.78(±2.96) ^{c} | −0.6(±0.06) ^{c} | 18.65(±0.18) ^{c} |
| | 3 | 64.65(±2.96) ^{d} | 0.86(±0.06) ^{d} | 28.65(±0.35) ^{d} |
| | 4 | 62.66(±2.96) ^{e} | 1.12(±0.07) ^{d, e} | 39.54(±0.25) ^{e} |
| | 5 | 60.23(±2.96) ^{f} | 1.88(±0.05) ^{f} | 47.89(±0.46) ^{f} |
| 400 ppm | 0 | 69.13(±2.96) ^{a} | −1.75(±0.07) ^{a} | 5.65(±0.07) ^{a} |
| DSE | 1 | 68.32(±2.96) ^{a, b} | −1.32(±0.05) ^{b} | 10.05(±0.08) ^{b} |
| | 2 | 66.68(±2.96) ^{c} | −0.8(±0.07) ^{c} | 17.25(±0.16) ^{c} |
| | 3 | 64.85(±2.96) ^{d} | 0.56(±0.04) ^{d} | 27.25(±0.25) ^{d} |
| | 4 | 63.06(±2.96) ^{e} | 1.05(±0.05) ^{e} | 38.14(±0.44) ^{e} |
| | 5 | 62.05(±2.96) ^{f} | 1.66(±0.05) ^{f} | 46.29(±0.46) ^{f} |
| 600 ppm | 0 | 68.75(±2.96) ^{a} | −1.68(±0.06) ^{a} | 5.85(±0.06) ^{a} |
| DSE | 1 | 68.12(±2.06) ^{a, b} | −1.44(±0.05) ^{a, b} | 9.85(±0.08) ^{b} |
| | 2 | 67.18(±2.36) ^{c} | −1.03(±0.07) ^{c} | 16.25(±0.16) ^{c} |
| | 3 | 66.05(±2.19) ^{d} | −0.95(±0.05) ^{c} | 25.25(±0.25) ^{d} |
| | 4 | 64.96(±2.76) ^{e} | 0.48(±0.05) ^{d} | 36.14(±0.29) ^{e} |
| | 5 | 63.23(±2.92) ^{f} | 1.16(±0.06) ^{e} | 45.19(±0.36) ^{f} |
| 800 ppm | 0 | 68.16(±2.04) ^{a} | −1.63(±0.07) ^{a} | 6.15(±0.07) ^{a} |
| DSE | 1 | 67.82(±2.18) ^{a, b} | −1.52(±0.06) ^{a, b} | 9.25(±0.08) ^{b} |
| | 2 | 67.08(±2.32) ^{b, c} | −1.13(±0.06) ^{c} | 15.65(±0.18) ^{c} |
| | 3 | 66.85(±2.54) ^{b, c} | −0.98(±0.04) ^{a} | 24.85(±0.25) ^{d} |
| | 4 | 65.96(±2.19) ^{d} | 0.39(±0.05) ^{d} | 35.14(±0.35) ^{e} |
| | 5 | 64.28(±2.33) ^{e} | 1.06(±0.04) ^{e} | 44.19(±0.16) ^{f} |
| 1000 ppm | 0 | 67.76(±2.54) ^{a} | −1.55(±0.06) ^{a} | 6.35(±0.07) ^{a} |
| DSE | 1 | 66.82(±2.16) ^{b} | −1.39(±0.05) ^{a, b} | 8.75(±0.06) ^{b} |
| | 2 | 66.28(±2.55) ^{b} | −1.03(±0.06) ^{c} | 13.25(±0.13) ^{c} |
| | 3 | 65.85(±2.76) ^{c} | −0.99(±0.05) ^{c} | 23.65(±0.19) ^{d} |
| | 4 | 64.96(±2.66) ^{d} | 0.28(±0.04) ^{d} | 34.74(±0.29) ^{e} |
| | 5 | 64.41(±2.26) ^{d} | 0.76(±0.06) ^{e} | 43.28(±0.46) ^{f} |
| 200 ppm | 0 | 70.22(±2.32) ^{a} | −2.12(±0.07) ^{a} | 5.72(±0.06) ^{a} |
| TBHQ | 1 | 68.82(±2.16) ^{b} | −1.84(±0.05) ^{a, b} | 10.15(±0.06) ^{b} |
| | 2 | 66.39(±2.69) ^{c} | −1.23(±0.07) ^{c} | 16.85(±0.18) ^{c} |
| | 3 | 65.05(±2.27) ^{d} | −0.65(±0.05) ^{d} | 25.65(±0.26) ^{d} |
| | 4 | 64.36(±2.35) ^{d} | 0.98(±0.04) ^{e} | 36.84(±0.35) ^{e} |
| | 5 | 63.41(±2.44) ^{e} | 1.26(±0.05) ^{f} | 45.69(±0.31) ^{f} |

Results are expressed in terms of mean±SD and represent the mean of 3 independent replicates. The value within the same column for a given oil differs significantly (p<0.05).

TABLE 4
The effect of DSE on the flavor, taste, appearance, and overall acceptability
of sunflower oil during French fries fried at different frying cycles.

| | Frying cycle | | | | Overall |
|---|---|---|---|---|---|
| | (in days) | Flavor | Taste | Appearance | Acceptability |
| Control | 0 | 8.44(±0.03)^{Aa} | 8.49(±0.02)^{Aa} | 8.39(±0.04)^{Aa} | 8.4(±0.03)^{Aa} |
| | 1 | 8.06(±0.02)^{ABa} | 8.12(±0.03)^{ABa} | 7.92(±0.04)^{Bb} | 8.02(±0.02)^{Ba} |
| | 2 | 7.78(±0.04)^{Ba} | 7.58(±0.03)^{Ba} | 7.64(±0.03)^{BCa} | 7.53(±0.02 ^{BCa} |
| | 3 | 5.16(±0.03) ^{Ca} | 7.01(±0.04) ^{Cbc} | 7.15(±0.02)^{Cc} | 6.67(±0.03)^{Cb} |
| | 4 | 4.48(±0.02)^{Da} | 6.05(±0.03) ^{Dc} | 6.88(±0.01)^{CDd} | 5.53(±0.03)^{Db} |
| | 5 | 3.12(±0.02) ^{Ea} | 3.65(±0.02) ^{Ea} | 6.14(±0.04) ^{Dc} | 4.77(±0.01)^{Eb} |
| 200 ppm | 0 | 8.44(±0.04)^{Aa} | 8.49(±0.03)^{Aa} | 8.39(±0.03)^{Aa} | 8.4(±0.02) ^{Aa} |
| DSE | 1 | 8.12(±0.02)^{ABa} | 8.16(±0.02)^{ABa} | 7.96(±0.02)^{Bab} | 8.05(±0.02) ^{Ba} |
| | 2 | 7.88(±0.01)^{Ba} | 7.62(±0.02)^{Ba} | 7.69(±0.03)^{BCa} | 7.59(±0.03)^{BCa} |
| | 3 | 6.66(±0.03)^{Ca} | 7.16(±0.03)^{Cb} | 7.19(±0.03)^{Cb} | 6.93(±0.03)^{Cab} |
| | 4 | 5.16(±0.02)^{Da} | 6.45(±0.03)^{Db} | 7.05(±0.02)^{CDbc} | 5.93(±0.02)^{Dab} |
| | 5 | 4.66(±0.02)^{Eab} | 4.36(±0.02)^{Ea} | 6.28(±0.03)^{Db} | 4.97(±0.01)^{Eab} |
| 400 ppm | 0 | 8.44(±0.02)^{Aa} | 8.49(±0.04)^{Aa} | 8.39(±0.02)^{Aa} | 8.4(±0.03)^{Aa} |
| DSE | 1 | 8.14(±0.02)^{ABa} | 8.17(±0.02)^{ABa} | 8.05(±0.03)^{Ba} | 8.07(±0.02)^{Ba} |
| | 2 | 7.96(±0.03)^{BCab} | 7.65(±0.03)^{Ba} | 7.78(±0.02) ^{BCa} | 7.65(±0.03)^{BCa} |
| | 3 | 7.06(±0.04)^{Ca} | 7.17(±0.03)^{BCab} | 7.42(±0.05)^{Cb} | 7.03(±0.02)^{Ca} |
| | 4 | 5.86(±0.03)^{Da} | 6.93(±0.02)^{Cbc} | 7.15(±0.04)^{CDc} | 6.22(±0.01)^{Db} |
| | 5 | 5.05(±0.02)^{Ea} | 5.16(±0.02)^{Da} | 6.38(±0.02)^{Db} | 5.37(±0.02)^{Ea} |
| 600 ppm | 0 | 8.44(±0.02)^{Aa} | 8.49(±0.02)^{Aa} | 8.39(±0.03)^{Aa} | 8.4(±0.02)^{Aa} |
| DSE | 1 | 8.15(±0.02)^{ABa} | 8.17(±0.03)^{ABa} | 8.08(±0.03)^{Ba} | 8.09(±0.02)^{Ba} |
| | 2 | 8.02(±0.04)^{BCa} | 7.69(±0.03)^{Bb} | 7.82(±0.04)^{BCab} | 7.69(±0.02)^{BCb} |
| | 3 | 7.16(±0.03)^{Da} | 7.18(±0.02)^{BCa} | 7.49(±0.03)^{Cab} | 7.08(±0.02)^{Ca} |
| | 4 | 6.08(±0.03)^{Ea} | 7.03(±0.03)^{Cbc} | 7.17(±0.02)^{CDc} | 6.68(±0.02)^{CDb} |
| | 5 | 5.65(±0.01)^{Fa} | 5.45(±0.01)^{Da} | 6.57(±0.02)^{Db} | 5.72(±0.01)^{Eab} |
| 800 ppm | 0 | 8.44(±0.01)^{Aa} | 8.49(±0.03)^{Aa} | 8.39(±0.02)^{Aa} | 8.4(±0.03)^{Aa} |
| DSE | 1 | 8.15(±0.02)^{ABa} | 8.18(±0.03)^{ABa} | 8.10(±0.03)^{Ba} | 8.10(±0.02)^{Ba} |
| | 2 | 8.04(±0.02)^{ABa} | 7.71(±0.02)^{Bab} | 7.85(±0.04)^{BCab} | 7.71(±0.03)^{BCab} |
| | 3 | 7.18(±0.03)^{Ca} | 7.20(±0.03)^{BCa} | 7.51(±0.02)^{Ca} | 7.11(±0.02)^{Ca} |
| | 4 | 6.38(±0.02)^{Da} | 7.06(±0.03)^{Cb} | 7.21(±0.02)^{CDb} | 6.91(±0.03)^{CDab} |
| | 5 | 5.95(±0.03)^{DEa} | 5.98(±0.02)^{Da} | 6.68(±0.01)^{Db} | 5.96(±0.01)^{Ea} |
| 1000 ppm | 0 | 8.44(±0.02)^{Aa} | 8.49(±0.02)^{Aa} | 8.39(±0.04)^{Aa} | 8.4(±0.02)^{Aa} |
| DSE | 1 | 8.16(±0.02)^{ABa} | 8.18(±0.01)^{ABa} | 8.11(±0.03)^{Ba} | 8.12(±0.03)^{Ba} |
| | 2 | 8.08(±0.04)^{ABa} | 7.73(±0.02)^{Bab} | 7.89(±0.01)^{BCab} | 7.76(±0.02)^{BCab} |
| | 3 | 7.38(±0.02)^{Ca} | 7.20(±0.02)^{BCa} | 7.56(±0.03)^{Ca} | 7.15(±0.03)^{Ca} |
| | 4 | 7.02(±0.03)^{CDa} | 7.06(±0.03)^{Ca} | 7.26(±0.03)^{CDab} | 7.09(±0.03)^{Ca} |
| | 5 | 6.73(±0.02)^{Da} | 6.26(±0.03)^{Dab} | 6.89(±0.02)^{Da} | 6.75(±0.02)^{Da} |
| TBHQ | 0 | 8.44(±0.03)^{Aa} | 8.49(±0.03)^{Aa} | 8.39(±0.02)^{Aa} | 8.4(±0.03)^{Aa} |
| | 1 | 8.14(±0.03)^{ABa} | 8.15(±0.03)^{ABa} | 8.07(±0.03)^{Ba} | 8.11(±0.03)^{Ba} |
| | 2 | 8.03(±0.03)^{ABa} | 7.65(±0.02)^{Bab} | 7.78(±0.01)^{BCab} | 7.65(±0.03)^{BCab} |
| | 3 | 7.19(±0.04)^{ABa} | 7.21(±0.03)^{BCa} | 7.41(±0.02)^{Cab} | 7.04(±0.02)^{Ca} |
| | 4 | 6.28(±0.02)^{Da} | 7.05(±0.02)^{Cb} | 7.13(±0.03) ^{CDb} | 6.74(±0.01)^{CDab} |
| | 5 | 5.85(±0.03)^{Ea} | 5.65(±0.01)^{Da} | 6.43(±0.02)^{Db} | 5.85(±0.02)^{Db} |

Means ± standard error within a column with the same uppercase letters is not significantly different at p < .05. Means ± standard error within a row with the same lowercase letters is not significantly different at p < 0.05.

### Sensory Evaluation of Fried Potato Samples

Sensory analysis evaluates a product's sensory qualities using human senses such as taste, smell, texture, and appearance. The sensory analysis provided valuable insights into the final, fried food product's overall quality and consumer acceptance in the market or among customers based on its sensory evaluation scores. The frying cycles from 0 to 5^{th} day demonstrated a lower sensory acceptance of all of the fried potato products, particularly the lowest acceptance value was observed in the fried potato products prepared in the control oil (see Table 4). However, a significant difference (P<0.05) was observed for the fried potato products prepared using a DSE-enriched sunflower oil sample, as a function of DSE content at the increased frying times. Furthermore, fried potato products fried in the 600 ppm DSE enriched edible oil had the same sensory acceptance value as the potato products fried in the 200 ppm TBHQ enriched edible oil. After the fifth day of the frying cycle, the fried potato products fried with 1000 ppm DSE-enriched oil were more acceptable among the sensory panelists, with a noticeable improvement in appearance, taste, and flavor compared to TBHQ and control oils. Without being bound by any particular theory, the polyphenolics present in the DSE additive may slow down the lipid oxidation of the edible oils that occurs during food-frying processes and/or food storage processes.

What is claimed is:

1. A composition for use in a food-frying process or a food-storage process, the composition comprising:
(a) an edible oil component, and
(b) a date seed extract.

2. The composition of claim 1, wherein the edible oil component comprises a plant-based edible oil, an animal-based edible oil or any combination thereof.

3. The composition of claim 2, wherein the plant-based edible oil is an avocado oil, an almond oil, an brazil nut oil, a canola oil, a cashew oil, a cocoa oil, a coconut oil, a corn oil, a cottonseed oil, a grapeseed oil, a hazel nut oil, a hemp oil, a macadamia nut oil, a palm oil, a rapeseed oil, a soybean oil, a mustard oil, a palm oil, a peanut oil, a rice bran oil, a safflower oil, an olive oil, a sesame oil, a sunflower oil, a walnut oil, a vegetable oil, a linseed oil or any combination thereof.

4. The composition of claim 1, wherein the date seed extract comprises a phenolic acid, a flavonoid, a flavone, a proanthocyanidin or any combination thereof.

5. The composition of claim 1 wherein the date seed extract comprises a hydroxycinnamate, an organic acid, a flavan-3-ol, a flavonol, a flavone, an anthocyanin derivative or any combination thereof.

6. The composition of claim 5, wherein the hydroxycinnamate is Caffeoyl-O-hexoside, 5-O-caffeoylshikimic acid (5-CSA), 4-O-caffeoylshikimic acid (5-CSA), 3-O-caffeoylshikimic acid (5-CSA), caffeoyl-2-hydroxyethane-1,1,2-tricarboxylic acid, feruloyl-O-p-coumaroyl-O-caffeoylshikimic acid, 3-O-feruloyl-7-O-acyl-feruloyl-4-O-caffeoyl-quinic acid, tri-caffeoylquinic acid or any combination thereof.

7. The composition of claim 5, wherein the organic acid is trihydroxy-octadecanoic acid isomer, trihydroxyoctadecanoic acid sulphate or any combination thereof.

8. The composition of claim 5, wherein the flavan-3-ol is (E) Catechin, (E) Catechin-(E) Catechin-(E) Catechin, (E) Catechin-(E) Catechin-(E) Catechin, (E) Catechin-(E) Gallocatechin, (E) Catechin-(E) Catechin or any combination thereof.

9. The composition of claim 5, wherein the flavanol and flavones are hexosylquercetin, dihexosylquercetin, gliricidin or 3-O-methylorobol, rhamnosylhexosyl luteolin, isorhamentin, rhamnosylhexosyl methyl quercetin, isorhamentin hexoside, kaempferol, isorhamentin, orientin, iso-orientin, orientin sulphate, iso-orientin sulphate, quercetin rutinoside, gliricidin, 3-O-methylorobol, chrysoeriol hexoside, quercetin or any combination thereof.

10. The composition of claim 5, wherein the anthocyanin derivative is cyanidin 3-O-glucoside, delphinidin-3-O-glucoside, petunidin-3-O-glucoside, peonidin-3-O-glucoside, malvidin-3-O-glucoside, cn-3-(6″-p-coumaroylglucoside), pt-3-(6″-p-coumaroylglucoside), dp-3-(6″-p-coumaroylglucoside) or any combination thereof.

11. The composition of claim 1, wherein the date seed extract is present within the composition at a desired concentration of between 10 ppm and 2500 ppm.

12. The composition of claim 5, wherein the date seed extract is present within the composition at a desired concentration of between 25 ppm and 1500 ppm.

13. A composition for use in a food-frying process or a food-storage process, the composition comprising:
(a) an edible oil component, and
(b) a naturally occurring composition that comprises a combination of a hydroxycinnamate, an organic acid, a flavan-3-ol, a flavonol, a flavone, an anthocyanin derivative or any combination thereof.

14. The composition of claim 13, wherein the hydroxycinnamate is Caffeoyl-O-hexoside, 5-O-caffeoylshikimic acid (5-CSA), 4-O-caffeoylshikimic acid (5-CSA), 3-O-caffeoylshikimic acid (5-CSA), caffeoyl-2-hydroxyethane-1,1,2-tricarboxylic acid, feruloyl-O-p-coumaroyl-O-caffeoylshikimic acid, 3-O-feruloyl-7-O-acyl-feruloyl-4-O-caffeoyl-quinic acid, tri-caffeoylquinic acid or any combination thereof.

15. The composition of claim 13, wherein the organic acid is trihydroxy-octadecanoic acid isomer, trihydroxyoctadecanoic acid sulphate or any combination thereof.

16. The composition of claim 13, wherein the flavan-3-ol is (E) Catechin, (E) Catechin-(E) Catechin-(E) Catechin, (E) Catechin-(E) Catechin-(E) Catechin, (E) Catechin-(E) Gallocatechin, (E) Catechin-(E) Catechin or any combination thereof.

17. The composition of claim 13, wherein the flavanol and flavones are hexosylquercetin, dihexosylquercetin, gliricidin or 3-O-methylorobol, rhamnosylhexosyl luteolin, isorhamentin, rhamnosylhexosyl methyl quercetin, isorhamentin hexoside, kaempferol, isorhamentin, orientin, iso-orientin, orientin sulphate, iso-orientin sulphate, quercetin rutinoside, gliricidin, 3-O-methylorobol, chrysoeriol hexoside, quercetin or any combination thereof.

18. The composition of claim 13, wherein the anthocyanin derivative is cyanidin 3-O-glucoside, delphinidin-3-O-glucoside, petunidin-3-O-glucoside, peonidin-3-O-glucoside, malvidin-3-O-glucoside, cn-3-(6″-p-coumaroylglucoside), pt-3-(6″-p-coumaroylglucoside), dp-3-(6″-p-coumaroylglucoside) or any combination thereof.

19. A food frying process comprising steps of:
(a) heating an edible oil and a date seed extract;
(b) positioning a food product into the heated edible oil.

20. The food frying process of claim 19, wherein the date seed extract is mixed with the edible oil before the step of heating.
